(19) United States
(12) Patent Application Publication
(10) Pub. No.: US 2018/0374021 A1
(43) Pub. Date: Dec. 27, 2018

(54) TRANSFER ROUTING AND APPOINTMENT OFFERING BASED ON SCHEDULED OR DYNAMIC ROUTES

(71) Applicant: Livible, Inc., Seattle, WA (US)

(72) Inventors: John Terrence Drayton, Medina, WA (US); Rodney Joe Hatfield, Seattle, WA (US); Robert Allen Jones, JR., Lake Mary, FL (US); Michael Laverne Smith, Tacoma, WA (US)

(21) Appl. No.: 15/633,671

(22) Filed: Jun. 26, 2017

(51) Int. Cl. G06Q 10/06; G06Q 10/08; G06N 5/04; G06N 99/00; G01C 21/34

(52) U.S. Cl. CPC G06Q 10/06315; G06Q 10/087; G01C 21/3484; G06N 5/04; G06N 99/005; G06Q 10/067

(57) ABSTRACT

Embodiments are directed towards a platform that enables users to schedule transfers of items to store at an off-premises storage stations or to deliver items that are currently stored off-premises. The platform may be selectively offer pickup/delivery slots to users. The platform may be arranged select slots to offer to users based on job size, location, item type, transfer agent capacity, or the like. The platform may be arranged to generate distribution routes for one or more transfer agents that perform the pickup/delivery jobs. The routes may be optimized to account real-time transfer agent capacity. For example, if pickups are cancelled additional pickups may be added to a route to use the excess capacity. Likewise, if deliveries are cancelled, additional transfer agent capacity may be added to accommodate the increase volume of items.

### TECHNICAL FIELD

This invention relates generally to pickup and delivery scheduling and more particularly, to scheduling pickup and delivery for offsite storage of personal property with local inventory management.

### BACKGROUND

Consumers are often confronted with where and/or how to store personal property. Typically, consumers rely on a combination of on-premises storage (e.g., closets, basements, attics, garages, and so on) and off-premises storage (e.g., offsite storage units). In some cases, consumers may prefer on-premises storage because its convenience. Whereas, off-premises storage may be preferred for less used items and/or if on-premises storage is consumed or otherwise unavailable. Further, in some cases, consumers may store some of their personal property at second homes or recreational properties. Also, as urban residences become more expensive affordability may be improved by providing smaller dwellings. However, smaller dwellings may be likely to have less room for storing personal property. Accordingly, consumers may store some of their items at off-premises storage facilities. Scheduling efficient pickup and delivery for items stored off-premises may be difficult or inconvenient. Thus, it is with respect to these considerations and others that these innovations have been made.

### BRIEF DESCRIPTION OF THE DRAWINGS

Non-limiting and non-exhaustive embodiments of the present innovations are described with reference to the following drawings. In the drawings, like reference numerals refer to like parts throughout the various figures unless otherwise specified. For a better understanding of the described innovations, reference will be made to the following Detailed Description of Various Embodiments, which is to be read in association with the accompanying drawings, wherein:

FIG. 1 illustrates a system environment in which various embodiments may be implemented;

FIG. 2 shows a schematic embodiment of a client computer;

FIG. 3 illustrates a schematic embodiment of a network computer;

FIG. 4 shows a logical schematic of a portion of an inventory system arranged to manage delivery routing and appointment offering based on scheduled trips in accordance with at least one of the various embodiments;

FIG. 5 shows a logical illustration of a system for associating labels with items in accordance with one or more of the various embodiments;

FIG. 6A shows a logical illustration of an interface for offering pickup or delivery slots to a user in accordance with one or more of the various embodiments;

FIG. 6B shows a logical illustration of a portion of a data model for offering pickup or delivery slots to a user in accordance with one or more of the various embodiments;

FIG. 7 illustrates a logical representation of a route for performing pickups or deliveries in accordance with one or more of the various embodiments;

FIG. 8 illustrates an overview flowchart for a process for managing delivery routing and appointment offering based on scheduled trips in accordance with one or more of the various embodiments;

FIG. 9 illustrates an overview flowchart for a process for appointment offering based on scheduled trips in accordance with one or more of the various embodiments;

FIG. 10 illustrates a flowchart for a process for providing appointment slots to users in accordance with one or more of the various embodiments;

FIG. 11 illustrates a flowchart for a process for providing real-time route modification in accordance with one or more of the various embodiments;

FIG. 12 illustrates a flowchart for a process for providing predictive models for job and route performance in accordance with one or more of the various embodiments; and

FIG. 13 illustrates a flowchart for a process for providing storage dimension estimates in accordance with one or more of the various embodiments.

### DETAILED DESCRIPTION OF THE INVENTION

Various embodiments now will be described more fully hereinafter with reference to the accompanying drawings, which form a part hereof, and which show, by way of illustration, specific exemplary embodiments by which the invention may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media or devices. Accordingly, the various embodiments may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

For example, embodiments, the following terms are also used herein according to the corresponding meaning, unless the context clearly dictates otherwise.

As used herein, the terms “inventory information,” or “item information” refer to information used to describe one or more characteristics of items management by an inventory platform. Item information may include, information such as, item location, item name, item description, height, weight, width volume, type of item, value, digital media (e.g., digital photographs, videos, audio, or the like), model, make, manufacturer, owner, color, or the like. Likewise, in some embodiments, item information may include indicators that the item may available for sale, rent, trade, sharing, borrowing, donation, or the like.

As used herein, the terms “off-premises storage station,” or “off-site storage location” refers to a storage location that is separate from a residence or other location associated with the owner of the items. Off-premises storage stations may also be separate from the inventory platform. In some cases, storage stations may be owned and/or operated by the inventory platform owner. In other cases, storage stations may be owned/operated by third-parties that may provide storage services to the inventory platform operator.

As used herein, the term “distribution organization” refers to an organization that is capable of acting on pickup and delivery instructions for transferring items from one location to another. In some cases, distribution organizations may be owned and/or operated by the operators of the inventory platform. In other cases, distribution organizations may be owned and/or operated by contracted operators.

As used herein, the term “scheduling option” refers to at least a defined delivery or pickup time window. In some cases, scheduling options may include date, time of day, range of time, delivery location, pickup location, type of items, number of items, cubic feet of items, or the like.

As used herein, the term “pickup instructions” refers to instructions provided to a delivery organization that enables them to collect/pickup items and deliver them to a storage station or another location.

As used herein, the term “delivery instructions” refers to instructions provided to a delivery organization that enables them to collect/pickup items from a storage station or other party and deliver them to a user at another location.

As used herein, the term “distribution instructions” refers to both pickup instructions and/or delivery instructions that may be provided to a distribution organization by the inventory platform.

As used herein, the term “item transfers” refers to either picking up items or delivering items.

As used herein, the term “appointment slot” refers to a data structure that represents a time window a user may use to select a time for a pickup or delivery. Appointment slots that are selected may be associated with additional information, such as, location pickup or delivery locations, information about the items to be collected or delivered (e.g., number of items, size of items, type of items, or the like), users that made the selections, or the like.

As used herein, the term “appointments” refer to appointment slots that have been selected by users for pickup or delivery of items. Appointments are appointment slots that are unavailable because they have been selected by users. If appointments are canceled the may revert back to appointment slots that may be offered to users.

As used herein, the term “job” refers to an appointment that has been assigned to a transfer agent or route for execution. Jobs that are canceled do not revert back to an appointment or appointment slots. Delivery instructions may be provided for each job

As used herein, the term “route” refers to a pickup of jobs that are scheduled to be performed in sequence. In some cases, jobs may be added or deleted from routes.

As used herein, the term “transfer agents” refers to vehicles that are used to execute jobs. Transfer agents may include various man or unmanned machines such as, automobiles, aerial drones, aircraft, robots, trucks, motorcycles, bicycles, watercraft, or the like. Also, in some cases, transfer agents may refer to couriers or the like that may be persons rather than vehicles. Transfer agents are assigned one or more jobs with the necessary distribution instructions. In some cases, transfer agents may be operated by one or more operators.

The following briefly describes the various embodiments to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, embodiments are directed towards a platform that enables users to schedule transfer of items to store at an off-premises storage stations or to deliver items that are currently stored off-premises.

In one or more of the various embodiments, the platform may be selectively offer pickup/delivery slots to users. The platform may be arranged select slots to offer to users based on job size, location, item type, transfer agent capacity, or the like.

In one or more of the various embodiments, the platform may be arranged to generate distribution routes for one or more transfer agents that perform the pickup/delivery jobs. The routes may be optimized to account real-time transfer agent capacity. For example, if pickups are cancelled additional pickups may be added to a route to use the excess capacity. Likewise, if deliveries are cancelled, additional transfer agent capacity may be added to accommodate the increase volume of items.

In one or more of the various embodiments, an inventory of items may be managed over a network using a network computer that includes one or more processors that perform actions, described below.

In one or more of the various embodiments, an inventory engine may be employed to collect information provided by a user of a client computer over a network and provide to the user one or more appointment slots based on item transfer information provided by the user and other item transfer information provided by one or more other users of one or more other client computers over the network.

In one or more of the various embodiments, a routing engine may be employed to provide one or more jobs based on each selection of the one or more appointment slots by the user, such that characterizing of the one or more jobs may be based on a type and a location included with the item transfer information.

In one or more of the various embodiments, one or more routes may be provided to perform the one or more jobs, such that each route is associated with one or more transfer agents.

In one or more of the various embodiments, metrics maybe provided for the one or more transfer agents based on monitoring one or more actions of the one or more transfer agents, such that the one or more monitored actions may stored in a remote data store.

In one or more of the various embodiments, a learning engine may be employed to compare metrics to one or more predictive models, such that the one or more predictive models may be based on previously obtained metrics.

In one or more of the various embodiments, a learning engine may be employed to use the one or more predictive models to modify the one or more routes based on the comparison, such that the modification of the one or more routes includes editing one or more characterizations of the one or more jobs to provide the one or more modified routes to the one or more transfer agents.

In one or more of the various embodiments, employing the one or more predictive models to modify the one or more routes, may include, modifying one or more paths to one or more of the jobs that may be associated with the one or more routes based on the provided metrics.

In one or more of the various embodiments, the inventory engine may be employed to perform further actions, including providing delivery instructions and pickup instructions to the one or more transfer agents, such that the delivery instructions and the pickup instructions are based on the one or more jobs and the one or more routes.

In one or more of the various embodiments, the inventory engine may be employed to rank order the one or more appointment slots based on the transfer information and the other transfer information.

In one or more of the various embodiments, the inventory engine may be employed to score appointment slots for item pickup based on their time window, such that item pickup appointment slots that have time windows that are later in time than previously scheduled delivery jobs are scored higher than item pickup appointment slots that have time windows that occur before the previously scheduled delivery jobs.

In one or more of the various embodiments, the inventory engine may be employed to rank order the one or more appointment slots based on the transfer information and the other transfer information.

In one or more of the various embodiments, the inventory engine may be employed to score appointment slots based on availability of the one or more transfer agents, such that more transfer agent capacity may be scored higher than less transfer agent capacity.

In one or more of the various embodiments, the inventory engine may be employed to provide one or more appointment slots for item pickup that may be associated with the one or more transfer agents that may be currently performing a route, such that the one or more transfer agents have excess available capacity to transfer one or more items.

In one or more of the various embodiments, employing the learning engine to use the one or more predictive models to predict one or more metrics for the one or more routes.

In one or more of the various embodiments, employing the learning engine to compare the one or more predicted metrics to the provided metrics.

In one or more of the various embodiments, employing the learning engine to retrain each predictive model that may be associated with a variance that exceeds a defined value.

### Illustrated Operating Environment

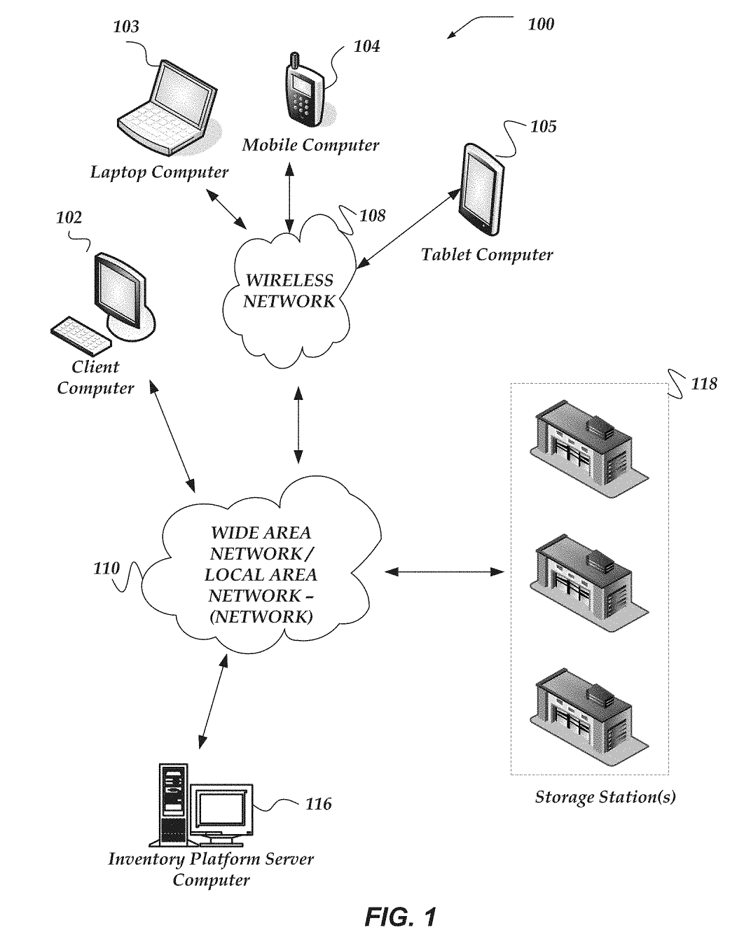

FIG. 1 shows components of one embodiment of an environment in which embodiments of the invention may be practiced. Not all the components may be required to practice the invention, and variations in the arrangement and type of the components may be made without departing from the spirit or scope of the invention. As shown, system 100 of FIG. 1 includes local area networks (LANs)/wide area networks (WANs)—(network) 110, wireless network 108, client computers 102-105, Inventory Platform Server Computer 116, one or more physical storage stations 118, or the like. In some embodiments, a storage station server computer (not shown) may be located at one or more storage stations 118. In other embodiments, users/operators at the one or more storage stations may employ one or more client computers, including mobile computers, smartphones, tablet computers, laptop computers, desktop computers, or the like, or combination thereof.

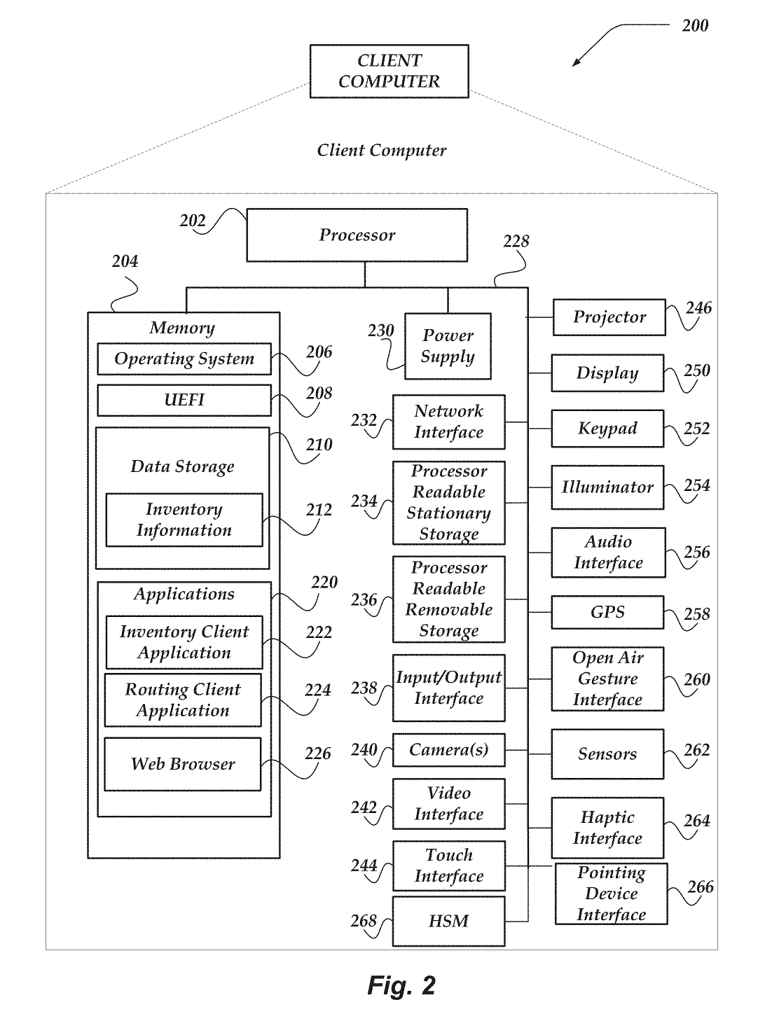

At least one embodiment of client computers 102-105 is described in more detail below in conjunction with FIG. 2. In one embodiment, at least some of client computers 102-105 may operate over one or more wired and/or wireless networks, such as networks 108, and/or 110. Generally, client computers 102-105 may include virtually any computer capable of communicating over a network to send and receive information, perform various online activities, offline actions, or the like. In one embodiment, one or more of client computers 102-105 may be configured to operate within a business or other entity to perform a variety of services for the business or other entity. For example, client computers 102-105 may be configured to operate as a web server, firewall, client application, media player, mobile telephone, game console, desktop computer, or the like. However, client computers 102-105 are not constrained to these services and may also be employed, for example, as for end-user computing in other embodiments. It should be recognized that more or less client computers (as shown in FIG. 1) may be included within a system such as described herein, and embodiments are therefore not constrained by the number or type of client computers employed.

Computers that may operate as client computer 102 may include computers that typically connect using a wired or wireless communications medium such as personal computers, multiprocessor systems, microprocessor-based or programmable electronic devices, network PCs, or the like. In some embodiments, client computers 102-105 may include virtually any portable computer capable of connecting to another computer and receiving information such as, laptop computer 103, mobile computer 104, tablet computers 105, or the like. However, portable computers are not so limited and may also include other portable computers such as cellular telephones, display pagers, radio frequency (RF) devices, infrared (IR) devices, Personal Digital Assistants (PDAs), handheld computers, wearable computers, integrated devices combining one or more of the preceding computers, or the like. As such, client computers 102-105 typically range widely in terms of capabilities and features. Moreover, client computers 102-105 may access various computing applications, including a browser, or other web-based application.

A web-enabled client computer may include a browser application that is configured to receive and to send web pages, web-based messages, and the like. The browser application may be configured to receive and display graphics, text, multimedia, and the like, employing virtually any web-based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), JavaScript Object Notation (JSON), or the like, to display and send a message. In one embodiment, a user of the client computer may employ the browser application to perform various activities over a network (online). However, another application may also be used to perform various online activities.

Client computers 102-105 also may include at least one other client application that is configured to receive and/or send content between another computer. The client application may include a capability to send and/or receive content, or the like. The client application may further provide information that identifies itself, including a type, capability, name, and the like. In one embodiment, client computers 102-105 may uniquely identify themselves through any of a variety of mechanisms, including an Internet Protocol (IP) address, a phone number, Mobile Identification Number (MIN), an electronic serial number (ESN), universally unique identifiers (UUIDs), or other device identifiers. Such information may be provided in a network packet, or the like, sent between other client computers, inventory platform server computer 116, or other computers.

Client computers 102-105 may further be configured to include a client application that enables an end-user to log into an end-user account that may be managed by another computer, such as inventory platform server computer 116, or the like. Such an end-user account, in one non-limiting example, may be configured to enable the end-user to manage one or more online activities, including in one non-limiting example, project management, software development, system administration, inventory management, search activities, social networking activities, browse various websites, communicate with other users, or the like. Further, client computers may be arranged to enable users to provide inventory information, label information, or the like, to inventory platform server computer 116, or the like. Also, client computers may be arranged to enable users to display reports, interactive user-interfaces, and/or results provided by inventory platform server computer 116.

Wireless network 108 is configured to couple client computers 103-105 and its components with network 110. Wireless network 108 may include any of a variety of wireless sub-networks that may further overlay stand-alone ad-hoc networks, and the like, to provide an infrastructure-oriented connection for client computers 103-105. Such sub-networks may include mesh networks, Wireless LAN (WLAN) networks, cellular networks, and the like. In one embodiment, the system may include more than one wireless network.

Wireless network 108 may further include an autonomous system of terminals, gateways, routers, and the like connected by wireless radio links, and the like. These connectors may be configured to move freely and randomly and organize themselves arbitrarily, such that the topology of wireless network 108 may change rapidly.

Wireless network 108 may further employ a plurality of access technologies including 2nd (2G), 3rd (3G), 4th (4G) 5th (5G) generation radio access for cellular systems, WLAN, Wireless Router (WR) mesh, and the like. Access technologies such as 2G, 3G, 4G, 5G, and future access networks may enable wide area coverage for mobile computers, such as client computers 103-105 with various degrees of mobility. In one non-limiting example, wireless network 108 may enable a radio connection through a radio network access such as Global System for Mobil communication (GSM), General Packet Radio Services (GPRS), Enhanced Data GSM Environment (EDGE), code division multiple access (CDMA), time division multiple access (TDMA), Wideband Code Division Multiple Access (WCDMA), High Speed Downlink Packet Access (HSDPA), Long Term Evolution (LTE), and the like. In essence, wireless network 108 may include virtually any wireless communication mechanism by which information may travel between client computers 103-105 and another computer, network, a cloud-based network, a cloud instance, or the like.

Network 110 is configured to couple network computers with other computers, including, inventory platform server computer 116, client computers 102-105 through wireless network 108, or the like. Network 110 is enabled to employ any form of computer readable media for communicating information from one electronic device to another. Also, network 110 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, and/or other carrier mechanisms including, for example, E-carriers, Integrated Services Digital Networks (ISDNs), Digital Subscriber Lines (DSLs), wireless links including satellite links, or other communications links known to those skilled in the art. Moreover, communication links may further employ any of a variety of digital signaling technologies, including without limit, for example, DS-0, DS-1, DS-2, DS-3, DS-4, OC-3, OC-12, OC-48, or the like. Furthermore, remote computers and other related electronic devices could be remotely connected to either LANs or WANs via a modem and temporary telephone link. In one embodiment, network 110 may be configured to transport information of an Internet Protocol (IP).

Additionally, communication media typically embodies computer readable instructions, data structures, program modules, or other transport mechanism and includes any information non-transitory delivery media or transitory delivery media. By way of example, communication media includes wired media such as twisted pair, coaxial cable, fiber optics, wave guides, and other wired media and wireless media such as acoustic, RF, infrared, and other wireless media.

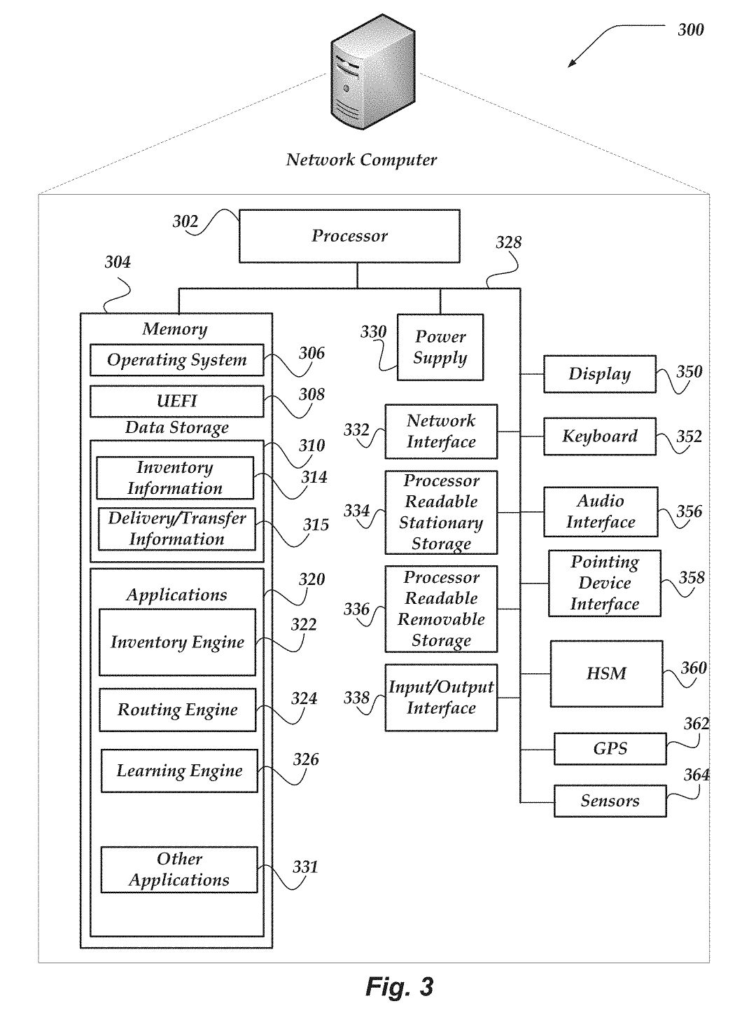

One embodiment of inventory platform server computer 116 is described in more detail below in conjunction with FIG. 3. Briefly, however, inventory platform server computer 116 includes virtually any network computer arranged to provide inventory management services for user as described herein.

Although FIG. 1 illustrates inventory platform server computer 116 as a single computer, the innovations and/or embodiments are not so limited. For example, one or more functions of inventory platform server computer 116, or the like, may be distributed across one or more distinct network computers. Moreover, inventory platform server computer 116 are not limited to a particular configuration such as the one shown in FIG. 1. Thus, in one embodiment, inventory platform server computer 116 may be implemented using a plurality of network computers. In other embodiments, server computers may be implemented using a plurality of network computers in a cluster architecture, a peer-to-peer architecture, or the like. Further, in at least one of the various embodiments, inventory platform server computer 116 may be implemented using one or more cloud instances in one or more cloud networks. Accordingly, these innovations and embodiments are not to be construed as being limited to a single environment, and other configurations, and architectures are also envisaged.

In one or more of the various embodiments, one or more of storage stations 118 may be owned and/or operated by the inventory platform owner. In other embodiments, one or more of storage stations 118 may be owned/operated by third-parties that may provide storage services to the inventory platform operator.

### Illustrative Client Computer

FIG. 2 shows one embodiment of client computer 200 that may include many more or less components than those shown. Client computer 200 may represent, for example, at least one embodiment of mobile computers or client computers shown in FIG. 1.

Client computer 200 may include processor 202 in communication with memory 204 via bus 228. Client computer 200 may also include power supply 230, network interface 232, audio interface 256, display 250, keypad 252, illuminator 254, video interface 242, input/output interface 238, haptic interface 264, global positioning systems (GPS) receiver 258, open air gesture interface 260, temperature interface 262, camera(s) 240, projector 246, pointing device interface 266, processor-readable stationary storage device 234, and processor-readable removable storage device 236. Client computer 200 may optionally communicate with a base station (not shown), or directly with another computer. And in one embodiment, although not shown, a gyroscope may be employed within client computer 200 to measuring and/or maintaining an orientation of client computer 200.

Power supply 230 may provide power to client computer 200. A rechargeable or non-rechargeable battery may be used to provide power. The power may also be provided by an external power source, such as an AC adapter or a powered docking cradle that supplements and/or recharges the battery.

Network interface 232 includes circuitry for coupling client computer 200 to one or more networks, and is constructed for use with one or more communication protocols and technologies including, but not limited to, protocols and technologies that implement any portion of the OSI model for mobile communication (GSM), CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. Network interface 232 is sometimes known as a transceiver, transceiving device, or network interface card (NIC).

Audio interface 256 may be arranged to produce and receive audio signals such as the sound of a human voice. For example, audio interface 256 may be coupled to a speaker and microphone (not shown) to enable telecommunication with others and/or generate an audio acknowledgement for some action. A microphone in audio interface 256 can also be used for input to or control of client computer 200, e.g., using voice recognition, detecting touch based on sound, and the like.

Display 250 may be a liquid crystal display (LCD), gas plasma, electronic ink, light emitting diode (LED), Organic LED (OLED) or any other type of light reflective or light transmissive display that can be used with a computer. Display 250 may also include a touch interface 244 arranged to receive input from an object such as a stylus or a digit from a human hand, and may use resistive, capacitive, surface acoustic wave (SAW), infrared, radar, or other technologies to sense touch and/or gestures.

Projector 246 may be a remote handheld projector or an integrated projector that is capable of projecting an image on a remote wall or any other reflective object such as a remote screen.

Video interface 242 may be arranged to capture video images, such as a still photo, a video segment, an infrared video, or the like. For example, video interface 242 may be coupled to a digital video camera, a web-camera, or the like. Video interface 242 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 252 may comprise any input device arranged to receive input from a user. For example, keypad 252 may include a push button numeric dial, or a keyboard. Keypad 252 may also include command buttons that are associated with selecting and sending images.

Illuminator 254 may provide a status indication and/or provide light. Illuminator 254 may remain active for specific periods of time or in response to events. For example, when illuminator 254 is active, it may backlight the buttons on keypad 252 and stay on while the client computer is powered. Also, illuminator 254 may backlight these buttons in various patterns when particular actions are performed, such as dialing another client computer. Illuminator 254 may also cause light sources positioned within a transparent or translucent case of the client computer to illuminate in response to actions.

Further, client computer 200 may also comprise hardware security module (HSM) 268 for providing additional tamper resistant safeguards for generating, storing and/or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, and/or store keys pairs, or the like. In some embodiments, HSM 268 may be arranged as a hardware card that may be added to a client computer.

Client computer 200 may also comprise input/output interface 238 for communicating with external peripheral devices or other computers such as other client computers and network computers. The peripheral devices may include an audio headset, display screen glasses, remote speaker system, remote speaker and microphone system, and the like. Input/output interface 238 can utilize one or more technologies, such as Universal Serial Bus (USB), Infrared, WiFi, WiMax, Bluetooth™, and the like.

Haptic interface 264 may be arranged to provide tactile feedback to a user of the client computer. For example, the haptic interface 264 may be employed to vibrate client computer 200 in a particular way when another user of a computer is calling. Open air gesture interface 260 may sense physical gestures of a user of client computer 200, for example, by using single or stereo video cameras, radar, a gyroscopic sensor inside a computer held or worn by the user, or the like. Camera 240 may be used to track physical eye movements of a user of client computer 200.

In at least one of the various embodiments, client computer 200 may also include sensors 262 for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), light monitoring, audio monitoring, motion sensors, or the like. Sensors 262 may be one or more hardware sensors that collect and/or measure data that is external to client computer 200

GPS transceiver 258 can determine the physical coordinates of client computer 200 on the surface of the Earth, which typically outputs a location as latitude and longitude values. GPS transceiver 258 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of client computer 200 on the surface of the Earth. It is understood that under different conditions, GPS transceiver 258 can determine a physical location for client computer 200. In at least one embodiment, however, client computer 200 may, through other components, provide other information that may be employed to determine a physical location of the client computer, including for example, a Media Access Control (MAC) address, IP address, and the like.

In at least one of the various embodiments, applications, such as, flow execution engine 222, web browser 226, or the like, may be arranged to employ geo-location information to select one or more localization features, such as, time zones, languages, currencies, calendar formatting, or the like. Localization features may be used in user-interfaces, reports, as well as internal processes and/or databases. In at least one of the various embodiments, geo-location information used for selecting localization information may be provided by GPS 258. Also, in some embodiments, geolocation information may include information provided using one or more geolocation protocols over the networks, such as, wireless network 108 and/or network 111.

Human interface components can be peripheral devices that are physically separate from client computer 200, allowing for remote input and/or output to client computer 200. For example, information routed as described here through human interface components such as display 250 or keyboard 252 can instead be routed through network interface 232 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™, Zigbee™ and the like. One non-limiting example of a client computer with such peripheral human interface components is a wearable computer, which might include a remote pico projector along with one or more cameras that remotely communicate with a separately located client computer to sense a user's gestures toward portions of an image projected by the pico projector onto a reflected surface such as a wall or the user's hand.

A client computer may include web browser application 226 that may be configured to receive and to send web pages, web-based messages, graphics, text, multimedia, and the like. The client computer's browser application may employ virtually any programming language, including a wireless application protocol messages (WAP), and the like. In at least one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTMLS, and the like.

Memory 204 may include RAM, ROM, and/or other types of memory. Memory 204 illustrates an example of computer-readable storage media (devices) for storage of information such as computer-readable instructions, data structures, program modules or other data. Memory 204 may store Unified Extensible Firmware Interface (UEFI) 208 for controlling low-level operation of client computer 200. The memory may also store operating system 206 for controlling the operation of client computer 200. It will be appreciated that this component may include a general-purpose operating system such as a version of UNIX, or LINUX™, or a specialized client computer communication operating system such as Windows Phone™. The operating system may include, or interface with a Java and/or JavaScript virtual machine modules that enable control of hardware components and/or operating system operations via Java application programs or JavaScript programs.

Memory 204 may further include one or more data storage 210, which can be utilized by client computer 200 to store, among other things, applications 220 and/or other data. For example, data storage 210 may also be employed to store information that describes various capabilities of client computer 200. The information may then be provided to another device or computer based on any of a variety of events, including being sent as part of a header during a communication, sent upon request, or the like. Data storage 210 may also be employed to store social networking information including address books, buddy lists, aliases, user profile information, or the like. Data storage 210 may further include program code, data, algorithms, and the like, for use by a processor, such as processor 202 to execute and perform actions. In some embodiments, data storage 210 may include inventory information 212 for locally storing inventory information. In one embodiment, at least some of data storage 210 might also be stored on another component of client computer 200, including, but not limited to, non-transitory processor-readable removable storage device 236, processor-readable stationary storage device 234, or even external to the client computer.

Applications 220 may include computer executable instructions which, when executed by client computer 200, transmit, receive, and/or otherwise process instructions and data. Applications 220 may include, for example, inventory client application 222, routing client application 224, or the like. In at least one of the various embodiments, inventory client application 222 may be used to interact with an inventory platform. Likewise, in one or more of the various embodiments, routing client application 224 may be arranged to enable transfer agent operators to view or otherwise interact with routing information that may be provided by an inventory platform.

Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth.

Additionally, in one or more embodiments (not shown in the figures), client computer 200 may include one or more embedded logic hardware devices instead of one or more CPUs, such as, an Application Specific Integrated Circuits (ASICs), Field Programmable Gate Arrays (FPGAs), Programmable Array Logic (PAL), or the like, or combination thereof. The embedded logic hardware devices may directly execute embedded logic to perform actions. Also, in one or more embodiments (not shown in the figures), the client computer may include one or more hardware microcontrollers instead of one or more CPUs. In at least one embodiment, the microcontrollers be system-on-a-chips (SOCs) that may directly execute their own embedded logic to perform actions and access their own internal memory and their own external Input and Output Interfaces (e.g., hardware pins and/or wireless transceivers) to perform actions.

### Illustrative Network Computer

FIG. 3 shows one embodiment of network computer 300 that may be included in a system implementing one or more embodiments of the described innovations. Network computer 300 may include many more or less components than those shown in FIG. 3. However, the components shown are sufficient to disclose an illustrative embodiment for practicing these innovations. Network computer 300 may represent, for example, one embodiment of inventory platform server computer 116, or, in some embodiments, one or more network computers located at storage station 118 of FIG. 1.

As shown in the figure, network computer 300 includes a processor 302 in communication with a memory 304 via a bus 328. Network computer 300 also includes a power supply 330, network interface 332, audio interface 356, global positioning systems (GPS) receiver 362, display 350, keyboard 352, input/output interface 338, processor-readable stationary storage device 334, and processor-readable removable storage device 336. Power supply 330 provides power to network computer 300. In some embodiments, processor 302 may be a multiprocessor system that includes one or more processors each having one or more processing/execution cores.

Network interface 332 includes circuitry for coupling network computer 300 to one or more networks, and is constructed for use with one or more communication protocols and technologies including, but not limited to, protocols and technologies that implement any portion of the Open Systems Interconnection model (OSI model), global system for mobile communication (GSM), code division multiple access (CDMA), time division multiple access (TDMA), user datagram protocol (UDP), transmission control protocol/Internet protocol (TCP/IP), Short Message Service (SMS), Multimedia Messaging Service (MMS), general packet radio service (GPRS), WAP, ultra wide band (UWB), IEEE 802.16 Worldwide Interoperability for Microwave Access (WiMax), Session Initiation Protocol/Real-time Transport Protocol (SIP/RTP), or any of a variety of other wired and wireless communication protocols. Network interface 332 is sometimes known as a transceiver, transceiving device, or network interface card (NIC). Network computer 300 may optionally communicate with a base station (not shown), or directly with another computer.

Audio interface 356 is arranged to produce and receive audio signals such as the sound of a human voice. For example, audio interface 356 may be coupled to a speaker and microphone (not shown) to enable telecommunication with others and/or generate an audio acknowledgement for some action. A microphone in audio interface 356 can also be used for input to or control of network computer 300, for example, using voice recognition.

Display 350 may be a liquid crystal display (LCD), gas plasma, electronic ink, light emitting diode (LED), Organic LED (OLED) or any other type of light reflective or light transmissive display that can be used with a computer. Display 350 may be a handheld projector or pico projector capable of projecting an image on a wall or other object.

Network computer 300 may also comprise input/output interface 338 for communicating with external devices or computers not shown in FIG. 3. Input/output interface 338 can utilize one or more wired or wireless communication technologies, such as USB™, Firewire™, WiFi, WiMax, Thunderbolt™, Infrared, Bluetooth™, Zigbee™, serial port, parallel port, and the like. GPS transceiver 362 can determine the physical coordinates of network computer 300 on the surface of the Earth, which typically outputs a location as latitude and longitude values. GPS transceiver 362 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of network computer 300 on the surface of the Earth. It is understood that under different conditions, GPS transceiver 362 can determine a physical location for network computer 300.

Network computer 300 may also include sensors 364 for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), light monitoring, audio monitoring, motion sensors, or the like. Sensors 364 may be one or more hardware sensors that collect and/or measure data that is external to network computer 300

In at least one embodiment, however, network computer 300 may, through other components, provide other information that may be employed to determine a physical location of the client computer, including for example, a Media Access Control (MAC) address, IP address, and the like.

Human interface components can be physically separate from network computer 300, allowing for remote input and/or output to network computer 300. For example, information routed as described here through human interface components such as display 350 or keyboard 352 can instead be routed through the network interface 332 to appropriate human interface components located elsewhere on the network. Human interface components include any component that allows the computer to take input from, or send output to, a human user of a computer. Accordingly, pointing devices such as mice, styluses, track balls, or the like, may communicate through pointing device interface 358 to receive user input.

Memory 304 may include Random Access Memory (RAM), Read-Only Memory (ROM), and/or other types of non-transitory computer readable and/or writeable media. Memory 304 illustrates an example of computer-readable storage media (devices) for storage of information such as computer-readable instructions, data structures, program modules or other data. Memory 304 stores a unified extensible firmware interface (UEFI) 308 for controlling low-level operation of network computer 300. The memory also stores an operating system 306 for controlling the operation of network computer 300. It will be appreciated that this component may include a general-purpose operating system such as a version of UNIX, or LINUX™, or a specialized operating system such as Microsoft Corporation's Windows® operating system, or the Apple Corporation's IOS® operating system. The operating system may include, or interface with a Java virtual machine module that enables control of hardware components and/or operating system operations via Java application programs. Likewise, other runtime environments may be included.

Memory 304 may further include one or more data storage 310, which can be utilized by network computer 300 to store, among other things, applications 320 and/or other data. For example, data storage 310 may also be employed to store information that describes various capabilities of network computer 300. The information may then be provided to another device or computer based on any of a variety of events, including being sent as part of a header during a communication, sent upon request, or the like. Data storage 410 may also be employed to store social networking information including address books, buddy lists, aliases, user profile information, or the like. Data storage 310 may further include program code, data, algorithms, and the like, for use by a processor, such as processor 302 to execute and perform actions such as those actions described below. In one embodiment, at least some of data storage 310 might also be stored on another component of network computer 300, including, but not limited to, non-transitory media inside processor-readable removable storage device 336, processor-readable stationary storage device 334, or any other computer-readable storage device within network computer 300, or even external to network computer 300. Data storage 310 may include, for example, inventory information 314, delivery/transfer information 315, or the like.

Applications 320 may include computer executable instructions which, when executed by network computer 300, transmit, receive, and/or otherwise process messages (e.g., SMS, Multimedia Messaging Service (MMS), Instant Message (IM), email, and/or other messages), audio, video, and enable telecommunication with another user of another mobile computer. Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth. Applications 320 may include inventory engine 322, routing engine 324, other applications 331, or the like, that may perform actions further described below. In at least one of the various embodiments, one or more of the applications may be implemented as modules and/or components of another application. Further, in at least one of the various embodiments, applications may be implemented as operating system extensions, modules, plugins, or the like.

In at least one of the various embodiments, applications, such as, inventory engine 322, routing engine 324, other applications 331, or the like, may be arranged to employ geo-location information to select one or more localization features, such as, time zones, languages, currencies, calendar formatting, or the like. Localization features may be used in user-interfaces, reports, as well as internal processes and/or databases. In at least one of the various embodiments, geo-location information used for selecting localization information may be provided by GPS 362. Also, in some embodiments, geolocation information may include information provided using one or more geolocation protocols over the networks, such as, wireless network 108 and/or network 111.

Furthermore, in at least one of the various embodiments, inventory engine 322, routing engine 324, or other applications 331, may be operative in a cloud-based computing environment. In at least one of the various embodiments, these engines, and others, that comprise the modeling platform that may be executing within virtual machines and/or virtual servers that may be managed in a cloud-based based computing environment. In at least one of the various embodiments, in this context applications including the engines may flow from one physical network computer within the cloud-based environment to another depending on performance and scaling considerations automatically managed by the cloud computing environment. Likewise, in at least one of the various embodiments, virtual machines and/or virtual servers dedicated to inventory engine 322, routing engine 324, learning engine 326, or other applications 331, may be provisioned and de-commissioned automatically.

Further, in some embodiments, network computer 300 may also include hardware security module (HSM) 360 for providing additional tamper resistant safeguards for generating, storing and/or using security/cryptographic information such as, keys, digital certificates, passwords, passphrases, two-factor authentication information, or the like. In some embodiments, hardware security module may be employ to support one or more standard public key infrastructures (PKI), and may be employed to generate, manage, and/or store keys pairs, or the like. In some embodiments, HSM 360 may be arranged as a hardware card that may be installed in a network computer.

Additionally, in one or more embodiments (not shown in the figures), network computer 300 may include an one or more embedded logic hardware devices instead of one or more CPUs, such as, Application Specific Integrated Circuits (ASICs), Field Programmable Gate Arrays (FPGAs), Programmable Array Logic (PALs), or the like, or combination thereof. The one or more embedded logic hardware devices may directly execute its embedded logic to perform actions. Also, in one or more embodiments (not shown in the figures), the network computer may include one or more hardware microcontrollers instead of one or more CPUs. In at least one embodiment, the one or more microcontrollers may directly execute embedded logic to perform actions and access their own internal memory and their own external Input and Output Interfaces (e.g., hardware pins and/or wireless transceivers) to perform actions. E.g., they may be arranged as Systems On Chips (SOCs).

### Illustrative Logical System Architecture

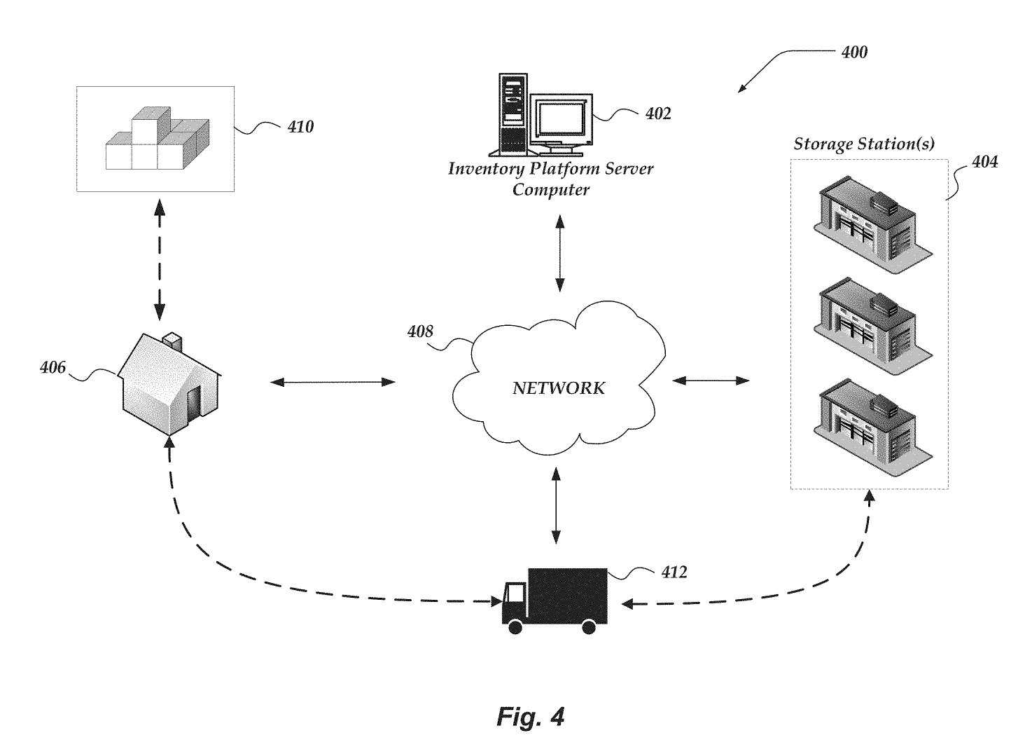

FIG. 4 shows a logical schematic of a portion of inventory system 400 arranged to manage transfer routing and appointment offering based on scheduled or dynamic trips in accordance with at least one of the various embodiments. In one or more of the various embodiments, inventory platform server computer 402, one or more storage stations, such as storage stations 404, residence 406, local property storage 410, and distribution organization 412 may be arranged to be communicatively coupled using one or more networks, such as network 408.

In one or more of the various embodiments, a user at residence 406 may use an inventory client application, such as, inventory client application 222 to provide inventory information to an inventory engine, such as inventory engine 322 that may be hosted on inventory platform server computer 402. Accordingly, in one or more of the various embodiments, inventory engine 322 may be arranged to store the inventory information on inventory platform server computer 402.

In one or more of the various embodiments, the user may indicate that one or more portions of their personal property should be stored an off-premises storage site. Accordingly, in one or more of the various embodiments, an inventory engine may be arranged to communicate with an off-site storage station, such as one of storage stations 404, and a distribution organization, such as distribution organization 412 to arrange for the one or more portions of their personal property to be transferred to one or more storage stations of storage stations 404.

In one or more of the various embodiments, storage stations 404 represent the one or more local or remote storage stations that may be used to store user items. In some embodiments, an inventory engine may be arranged to select a particular storage station based on various factors, such as, item location, item type, user input, storage station capacity/utilization, or the like, or combination thereof. Accordingly, in one or more of the various embodiments, the inventory engine may be arranged to apply one or more rule-based policies, predictive models, configuration information, or the like, to select a particular storage station for storing items.

In one or more of the various embodiments, inventory information associated with the user's personal property may be arranged to include various characteristics of the property. In some embodiments, these characteristics may include, name, category, description, photographs, height, width, weight, owner (e.g., which family member owns the item, or the like), storage location, or the like. In one or more of the various embodiments, inventory information may be associated with items using identifiers affixed (e.g., bar codes, QR codes, serial numbers, or the like) or included (e.g., RFID, NFC, beacons, or the like) to labels that are attached to the items. In some embodiments, these labels may be attached to a container (e.g., a box) where the item is placed.

In one or more of the various embodiments, if a user designates that items should be stored off-site, the inventory platform may provide scheduling options including one or more available pickup slots. Accordingly, the user may select a slot that defines a time window for the item to be picked up. Next, in one or more of the various embodiments, the inventory platform may employ a routing engine to provide pickup instructions that may include a delivery route and schedule to distribution organization 412. In one or more of the various embodiments, distribution organization 412 may then collect the items at residence 406 and transfer them to storage stations 404.

Likewise, in one or more of the various embodiments, a user may request to retrieve items from off-premises storage. Accordingly, in some embodiments, the user may employ an inventory client application to submit a request for the item to be retrieved from off-premise storage and delivered to their residence. In one or more of the various embodiments, the request may include delivery schedule options, such as a requested time-window for receiving the delivery.

Next, in one or more of the various embodiments, the inventory platform may employ the inventory engine to locate the requested items and employ the routing engine to provide delivery instructions that may include a route and schedule for delivery of the requested items.

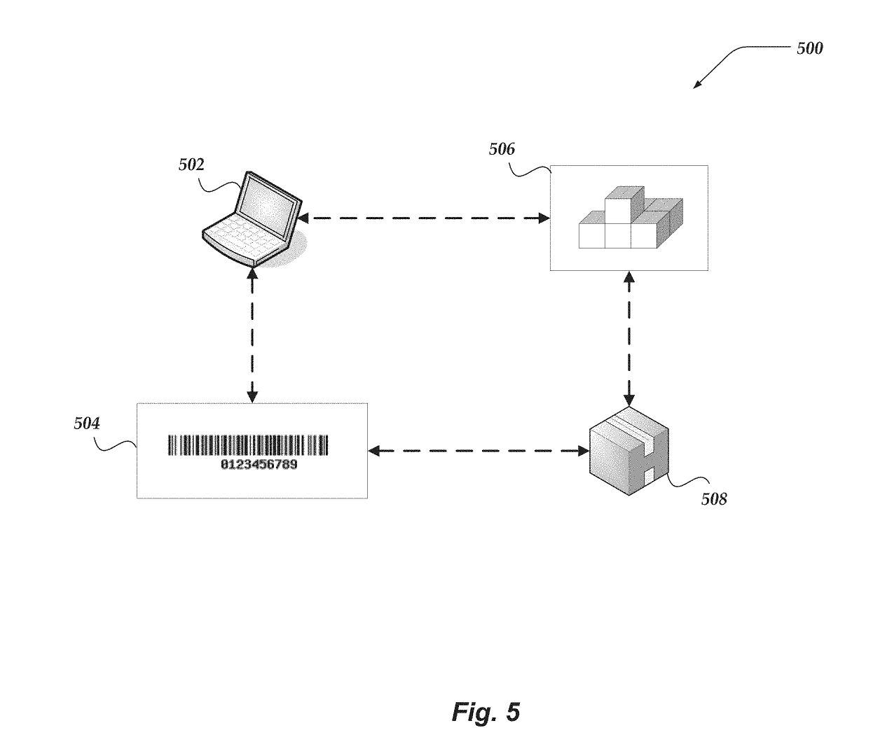

FIG. 5 shows a logical illustration of system 500 for associating labels with items in accordance with one or more of the various embodiments. In one or more of the various embodiments, a label affixed to user items (or affixed to a container for items) may be used for maintaining inventory control over user personal property items. In some embodiments, a label such as label 504 may be associated with a user via client computer 502. Likewise, label 504 may be associated with personal property item 508. Inventory information may be associated with label 504 and stored on an inventory platform server. As described above, inventory information may include location information. Accordingly, if personal property item 508 is stored at an inventory location, such as inventory location 506, location information associated with the property may be updated and associated with label 504.

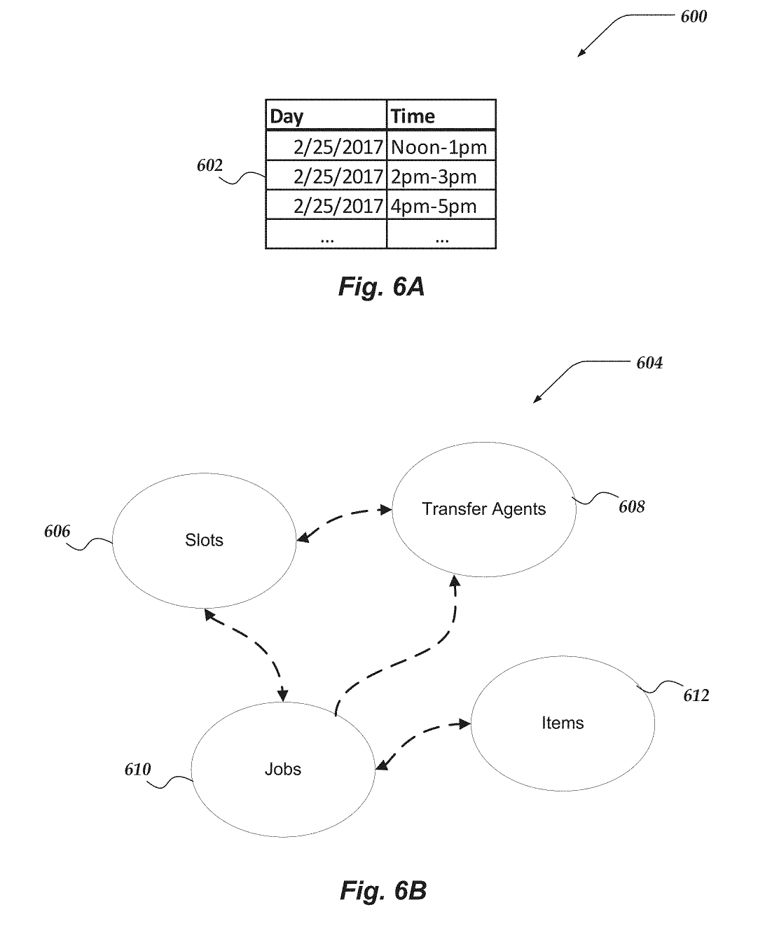

FIG. 6A shows a logical illustration of interface 600 for offering pickup or delivery slots to a user in accordance with one or more of the various embodiments. In one or more of the various embodiments, if a user has select one or more items for pickup or delivery, the platform may provide a list of available slots that the user may select from. In one or more of the various embodiments, the offered time slots may be selected based on various factors, such as, other scheduled pickups, other scheduled deliveries, transfer agent capacity, item types, number items, volume of items, or the like, or combination thereof. In one or more of the various embodiments, row 602 includes a date and time window for the slot. Accordingly, in some embodiments, the user may select a desired slot for their pickup or delivery.

For example, in one or more of the various embodiments, if other users near the user have already scheduled deliveries or pickups, the platform may display slots that are near in time the nearby users. In some embodiments, slots that require the least amount of energy to accommodate may be highlighted as being energy-friendly or environmentally friendly. Accordingly, in some embodiments, such slots may be indicated by a description, tool-tips, icon, color scheme, or the like.

In one or more of the various embodiments, the offered slots may depend on whether the items are being collected or delivered. For example, in some embodiments, deliveries may be scheduled before pickups to enable a transfer agent that is loaded at the storage station to unload items for deliveries before loading more items for pickups.

FIG. 6B shows a logical illustration of a portion of data model 604 for offering pickup or delivery slots to a user in accordance with one or more of the various embodiments. In one or more of the various embodiments, data model 604 may be arranged to include one or more data objects, such slot object 606, transfer agent object 608, job object 610, item object 612, or the like. In one or more of the various embodiments, the various data object may represent multiple instances of the underlying records or objects. For example, in one or more of the various embodiments, slots object 606 may represent the available or assigned slots. Likewise, transfer agents object 608 may represent transfer agents (e.g., cargo transfer agents) that may be used for pickup or delivery of items. Further, in this example, jobs object 610 may represent jobs comprising a pickup of items that may need to be collected or delivered. And, in this example, items object 612 may be arranged to represent the items that may be collected or delivered.

In one or more of the various embodiments, several other data objects (not shown), such as user objects, location objects, storage station objects, route objects, or the like, may be included in a data model, such as data model 604. However, the objects shown here are sufficient for describing the innovation herein. Accordingly, for brevity and clarity they have been omitted.

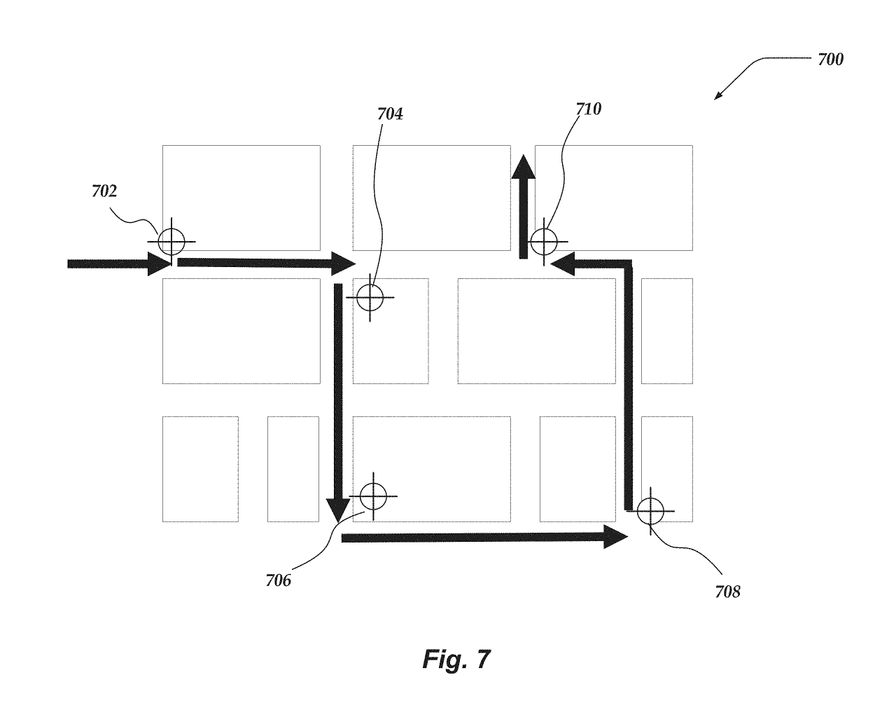

FIG. 7 illustrates a logical representation of route 700 for performing pickups or deliveries in accordance with one or more of the various embodiments. In one or more of the various embodiments, a system, such as inventory platform 116 may be arranged to provide one or more distribution routes that may be assigned to transfer agents that may be performing pickups or deliveries. In one or more of the various embodiments, routes, such as route 700 may include various stops, such as, stop 702, stop 704, stop 706, stop 708, stop 710, or the like. In one or more of the various embodiments, stops may be pickups or deliveries, or in some cases, a combination of pickups and deliveries at the same location.

In one or more of the various embodiments, routes may be planned in advance and then modified by the platform, a user, a transfer agent driver, or the like. In some embodiments, circumstances of planned pickups or deliveries may change after a transfer agent has left a storage station. In some cases, for some embodiments, the platform may be able to dynamically modify the route to mitigate problems that may be introduced by unexpected changes. Likewise, in some embodiments, circumstances of planned pickups or deliveries may change after a transfer agent has left a storage station. In some cases, for some embodiments, the platform may be enabled to dynamically modify the route to mitigate problems that may be introduced by unexpected changes. Likewise, in some embodiments, the platform may be arranged to dynamically modify a route to optimize it in view of the modifications.

### Generalized Operations

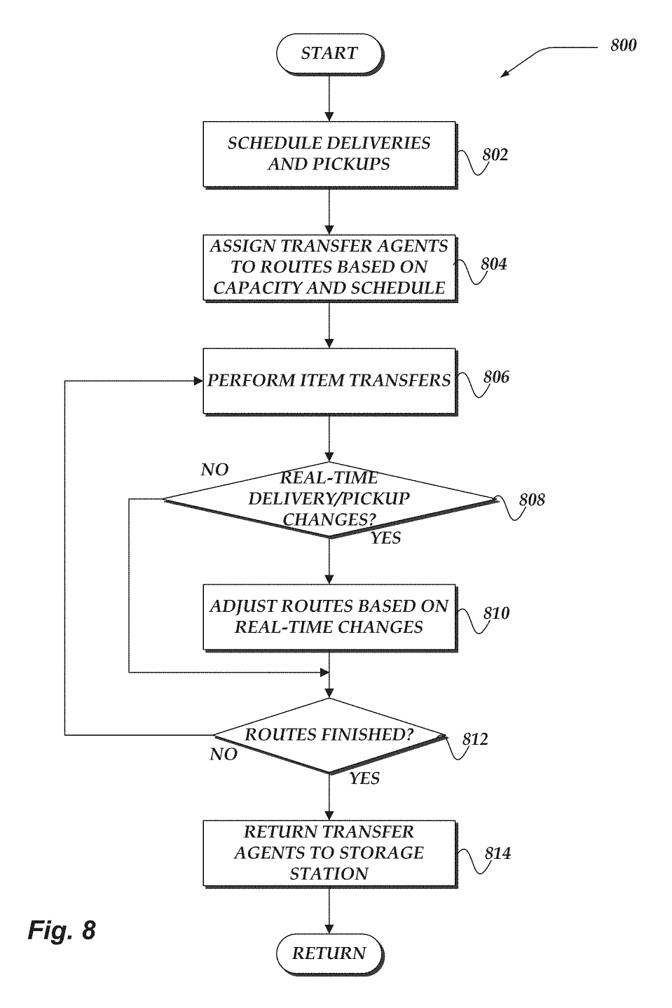

FIGS. 8-12 represent the generalized operations for managing transfer routing and appointment offering based on scheduled or dynamic routes in accordance with at least one of the various embodiments. In one or more of the various embodiments, processes 800, 900, 1000, 1100, and 1200 described in conjunction with FIGS. 8-12 may be implemented by and/or executed on a single network computer, such as network computer 300 of FIG. 3. In other embodiments, these processes or portions thereof may be implemented by and/or executed on a plurality of network computers, such as network computer 300 of FIG. 3. However, embodiments are not so limited, and various combinations of network computers, client computers, virtual machines, or the like may be utilized. Further, one or more of the various embodiments, the processes described in conjunction with FIGS. 8-12 may be operative in managing delivery routing and appointment offering based on scheduled trips such as described in conjunction with FIGS. 4-7.

FIG. 8 illustrates an overview flowchart for process 800 for managing transfer routing and appointment offering based on scheduled or dynamic trips in accordance with one or more of the various embodiments. After a start block, at block 802, in one or more of the various embodiments, an inventory management platform may be arranged to schedule one or more jobs such as deliveries and pickups. Pickups may be appointments to pick up items selected by a user (e.g., for storing at a storage station) while deliveries may be appointments to deliver items to a user.

At block 804, in one or more of the various embodiments, one or more routes may be provided based on transfer agent capacity, scheduled appointments, or the like. In one or more of the various embodiments, the routes may be communicated to one or more distribution organizations that may be providing the transfer agents. In one or more of the various embodiments, transfer agent operators may be equipped with client computers, such as, mobile computer, smartphones, or the like, that may be arranged to execute client programs associated with the inventory platform. Accordingly, in some embodiments, the transfer agent operators may view and interact with the route information using an application, such as, routing client application 224.

At block 806, in one or more of the various embodiments, the transfer agents (e.g., the distribution organization) may perform the various deliveries or pickups that may be associated with provided routes. In one or more of the various embodiments, each transfer agent may be assigned its own route that includes deliveries and pickups.

In one or more of the various embodiments, the inventory platform may be arranged to monitor the executions of jobs or routes to collect various performance metrics that may be used to adapt future routes or appointment scheduling. Also, in one or more of the various embodiments, performance metrics may be used to determine real-time route adjustments.

In one or more of the various embodiments, information for performance metrics may be provided from various sources or sensors, such as, transfer agent operators, transfer agent operators' mobile computers, mobile computers embedded in the transfer agents, customer input, third parties (e.g., traffic/map services), or the like, or combination thereof.

At decision block 808, in one or more of the various embodiments, if there are real-time changes to one or more deliveries or pickups, control may flow to block 810; otherwise, control may flow decision block 812. In one or more of the various embodiments, circumstances of one or more deliveries or pickups may change. For example, in some embodiments, one or more users may unexpectedly cancel a delivery or pickup job. In other examples, a user may be absent or otherwise fail to allow the transfer agent to complete a delivery or pickup job.

At block 810, in one or more of the various embodiments, one or more routes may be adjusted based on the real-time changes that may have occurred. In some embodiments, the inventory platform may be arranged to monitor the status of the routes/jobs that may be in process. In one or more of the various embodiments, transfer agents operators may employ a mobile computer to that automatically tracks their location with respect to their assigned routes. Accordingly, in some embodiments, the inventory platform may be provided various job metrics as jobs for a given route are processed.

Accordingly, in one or more of the various embodiments, the inventory platform may be arranged dynamically adjust one or more routes in real-time. In one or more of the various embodiments, if routes are adjusted, the inventory platform may be communicate the adjustments to a mobile computer associated with affected transfer agents. In some embodiments, some adjustments may require notifying transfer agent operators while some adjustments may be made automatically without input from transfer agent operators.

In one or more of the various embodiments, the transfer agent operators may initiate an adjustment by communicating a request or notice to the inventory platform. Likewise, in some embodiments, the inventory platform may be arranged to request information from transfer agent operators to use for monitoring or adjusting routes. For example, in one or more of the various embodiments, the inventory platform may ask a transfer agent operators to confirm if the traffic is congested, or the like.

In one or more of the various embodiments, route adjustments may include altering appointment slot times or time-windows, adding additional transfer agent or transfer agent operators to routes, altering the order of jobs, modifying the route path of the transfer agent, canceling/rescheduling jobs, or the like. In some embodiments, some route adjustments may include notifying customers or transfer agent operators whereas other route adjustments may be made without notifying customers or transfer agent operators.

In one or more of the various embodiments, one or more adjustments may require transfer agent operator or customer confirmation/approval before be applied. For example, in one or more of the various embodiments, changing an appointment time may require the customer to confirm or otherwise accept the change. Likewise, for example, in one or more of the various embodiments, an adjustment that adds jobs to a route may require a transfer agent operator to approve or override the change.

At decision block 812, in one or more of the various embodiments, if the one or more routes are completed, control may flow to block 814; otherwise, control may loop back to block 806 to continue executing the one or more routes. In one or more of the various embodiments, the inventory platform may be arranged to monitor performance metrics associated with routes or jobs until they are completed. Accordingly, in one or more of the various embodiments, the inventory platform may determine if transfer agents have completed their routes.

At block 814, in one or more of the various embodiments, the transfer agents may be directed to return to one or more storage stations. At the completion of their routes the transfer agents may be released or otherwise directed to a stand down location. In one or more of the various embodiments, transfer agents that have completed their routes may be re-assigned to assist other routes. For example, in some embodiments, if a transfer agent has capacity it may be assigned jobs from other routers.

Next, in some embodiments, control may be returned to a calling process.

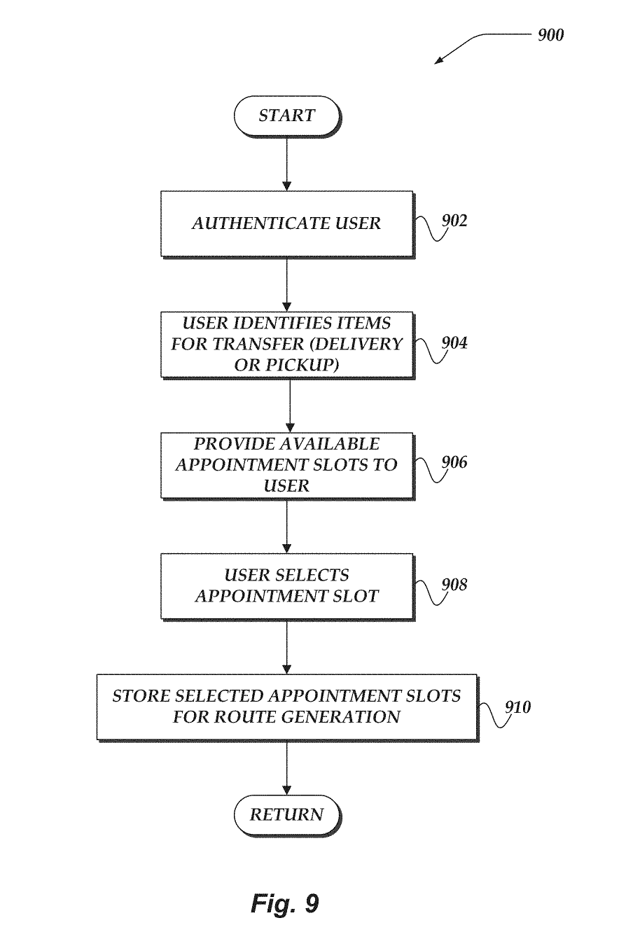

FIG. 9 illustrates an overview flowchart for process 900 for appointment offering based on scheduled trips in accordance with one or more of the various embodiments. After a start block, at block 902, in one or more of the various embodiments, a user may be authenticated by the inventory platform. In one or more of the various embodiments, the user may be enabled to provide various credentials to authenticate with the inventory platform. In one or more of the various embodiments, the credentials may include, usernames, passwords, biometric information (e.g., fingerprints, voice prints, retinal information, or the like), pin numbers, cryptographic certificates, device information/identities, or the like, or combination thereof.

In one or more of the various embodiments, the inventory platform may authenticate the user based on their credentials. Accordingly, in some embodiments, access to one or more features of the inventory platform may be provided to the user based on their access permissions.

In one or more of the various embodiments, the inventory platform may be arranged to authenticate users by employing one or more external services. In some embodiments, the inventory platform may be configured to employ authentication services offered by one or more social media platforms to authenticate users. For example, in some embodiments, the inventory platform may be arranged to employ an open standard for authorization (OAuth) to authenticate a user by way of one or more of their social media accounts.

At block 904, in one or more of the various embodiments, the authenticated user may select one or more items from their inventory catalog. In one or more of the various embodiments, the inventory platform may provide the inventory catalog to an inventory client application running on a client computer. In some embodiments, the inventory client application may be a web application running in a web browser. In other embodiments, the inventory client application may be native application running on a client computer, such as, a mobile computer, tablet computer, smart phone, or the like.

In one or more of the various embodiments, the inventory catalog may be arranged to be searched and/or browsed by the user so they may identify items and review the corresponding item information. In one or more of the various embodiments, the inventory catalog may include items stored locally (e.g., on-premises) or items stored off-premises at a storage station. Accordingly, in one or more of the various embodiments, the user may select items for: retrieval from off-premises storage; update item information for selected items; select items for pickup off-premises storage, or the like.

In one or more of the various embodiments, the inventory client application and/or the inventory platform may be arranged to accept voice commands in lieu of other inputs, such as keyboard, touch, or the like.

At block 906, in one or more of the various embodiments, the inventory platform may be arranged to provide one or more appointment slots to the user. In one or more of the various embodiments, the available appointment slots may be presented to the user in the form of a user-interface that enables the user select one or more slots.

In one or more of the various embodiments, the particular appointment slots provided to a user or customer may be influenced by various factors, including, the type of actions the user is requesting (e.g., pickups or deliveries), characteristics of the items selected for pickup or delivery (e.g., volume, weight, special attributes, or the like), pickup/delivery location, lead time before actions, or the like, or combination thereof.

In one or more of the various embodiments, the inventory platform may be arranged to present the available appointments in a rank order or otherwise indicate to the user one or more preferred appointment slots. For example, in one or more of the various embodiments, slots that are more energy efficient may be emphasized using an icon or labeling that reflects that one or more slots may be better for the environment.

At block 908, in one or more of the various embodiments, the user may select one or more appointment slots. In one or more of the various embodiments, the user may indicate via the user-interface one or more appointment slots that may be acceptable. In one or more of the various embodiments, the user's appointment slot request/selection may be communicated to the inventory platform.

At block 910, in one or more of the various embodiments, the inventory platform may store the selected appointment slots for subsequent transfer agent route generation and appointment offering. In one or more of the various embodiments, as users make appointments it will affect the appointment slots that may be available other users. Also, in one or more of the various embodiments, the inventory platform may be arranged generate tentative transfer agent routes or route information that may be employed if offering appointment slots to subsequent users. In one or more of the various embodiments, job information, such as, location, items, volume of items, or the like, may be associated with the appointment slots selected by the user.

Next, in one or more of the various embodiments, control may be returned to a calling process.

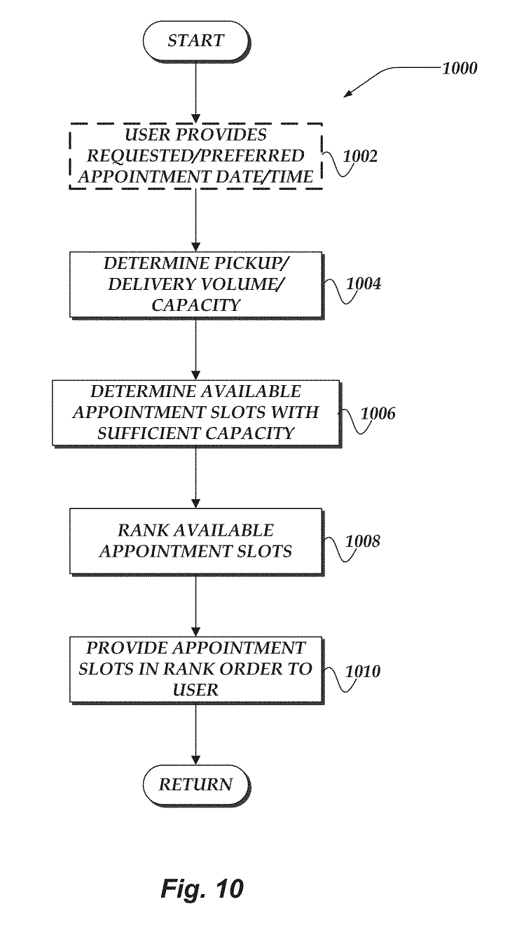

FIG. 10 illustrates a flowchart for process 1000 for providing appointment slots to users in accordance with one or more of the various embodiments. After a start block, at block 1002, in one or more of the various embodiments, optionally, a user may provide a requested or preferred date and time for an appointment. In one or more of the various embodiments, a user interface provided to the user may be arranged to enable the user to provide a requested or preferred date or time. In one or more of the various embodiments, the inventory platform may be arranged to select a default date time based on a defined configuration value or user preference,

In one or more of the various embodiments, this block may be considered optional because in some embodiments, the inventory platform may be configured to automatically provide appointment slots absent the user selecting a preferred date/time. For example, the inventory platform may be arranged to automatically select a date/time that is two-weeks from the date/time the request is provided by the user.

At block 1004, in one or more of the various embodiments, an inventory platform may be arranged to determine the pickup/delivery volume already assigned or allocated to appointment slots near the time for selected for the authenticated user. In some embodiments, the appointment slots selected for volume determination may be selected based on a date/time requested by the user, or an automatic or default time based on configuration and defined time-window. For example, in some embodiments, the inventory platform may be arranged select a range of appointment slots that are plus-or-minus three days from the time selected for a particular user.

In one or more of the various embodiments, the inventory platform may be arranged to estimate the volume required for a given job based on the items that the user has selected. For example, item information associated with items included in a user's item catalog may include values representing the volume (e.g., van space) consumed by each item.

At block 1006, in one or more of the various embodiments, the inventory platform may be arranged to determine one or more available appointment slots that have sufficient capacity for the job (e.g., pickup, delivery, or the like). In one or more of the various embodiments, slots may be assigned a capacity value associated with the size or number of the transfer agents that may be used by the distribution organization. Accordingly, in some embodiments, the inventory platform may be arranged to identify appointment slots that may have sufficient capacity for the items selected by a user.

In one or more of the various embodiments, the inventory platform may be arranged to build in time buffers to accommodate the risk of unplanned delay. In one or more of the various embodiments, the size/duration of the time buffers may be assigned based on configuration information. In some embodiments, the configuration information may include scripts or programs that dynamically adjust the appointment windows time buffers based on real-time factors. In some embodiments, real-time factors may include, size of jobs, time of day, predicted traffic congestion, time of year, weather forecast, historical information for a particular user, historical information for a particular location, types of items to be collected or delivered, pickup/delivery balance, elastic transfer agent/operator capacity, or the like, or combination thereof.

In one or more of the various embodiments, buffer adjustments based on size of jobs may account for different size jobs having different duration variability. For example, historical information may indicate that large jobs with many items may have more variability in actual versus planned duration. Accordingly, a time buffer may be adjusted to accommodate risk associated with job size.

In one or more of the various embodiments, time-of-day may impact risk depending on traffic, building access, backup transfer agent availability, or the like. Likewise, in some embodiments, appointments scheduled during periods of high traffic congestion may be more susceptible to unplanned traffic delays.

At block 1008, in one or more of the various embodiments, the inventory platform may be arranged to rank the available appointment slots based on various characteristics associated with the job, such as, location, time of day, number of filled slots for a day, or the like, or combination thereof. In one or more of the various embodiments, the ranking of slots may be rank ordered based on one or more rule based policies used by the inventory platform. In some embodiments, a policy may be arranged to rank slots such that slots that may provide more efficient routes are preferred. For example, in one or more of the various embodiments, a policy may be arranged to categorize a pickup slot at a location near the location of prior scheduled delivery slot as preferred since a transfer agent may unload items at the nearby delivery location and then collect the items at the nearby pickup location.

In one or more of the various embodiments, other ranking preferences may be driven by policies that prefer deliveries to be scheduled earlier in the day than pickups. Accordingly, in some embodiments, a transfer agent may leave the storage station loaded with items for delivery. Thus, there will likely be room in the same transfer agent for picking up items later in the day after deliveries are made.

In one or more of the various embodiments, policies for slot ranking may also include accounting for transfer agent or transfer agent operator availability. For example, in some embodiments, if transfer agent operators are scarce on certain days or times, a policy may rank corresponding appointment slots lower than other days or times.

In one or more of the various embodiments, the ranking process may include determining the range or number of appointment slots to offer to a customer. In some embodiments, the inventory platform may be configured to show a minimum number or maximum number of slots. Likewise, in some embodiments, the inventory platform may be configured to show a slots within a minimum time range or slots within a maximum time range. For example, in one or more of the various embodiments, an inventory platform may be arranged to show at least 4 appointment slots for a user. Alternatively, for example, an inventory platform may be arranged to show all the available slots in a 72 hour time range.

In one or more of the various embodiments, the inventory platform may be arranged to select the number or range of appointment slots by executing one or more function included in rule based policies or scripts/programs. In one or more of the various embodiments, such functions may be arranged to take into account predicted metrics or real-time metrics. In one or more of the various embodiments, predicted metrics may include metrics provided using one or more predictive models generated by machine learning analysis of historical metrics.

At block 1010, in one or more of the various embodiments, the inventory platform may be arranged to provide the ranked the available appointment slots to user. In one or more of the various embodiments, the available appointment slots may be provided to a user via a user interface. For example, an inventory platform may be arranged to communicate information regarding the selected available appointment slots to an inventory client application, such as inventory client application 222 that may be running on the user's client computer. As described above, in one or more of the various embodiments, the user interface that displays the appointment slots may be arranged show or indicate one or more top ranked appointment slots as preferred. For example, in some embodiments, if a slot may be top ranked because it is predicted to be the most energy efficient, the user interface may use icons, labeling, or the like, to indicate that slot as being as “green” or otherwise an energy saving choice.

Next, in one or more of the various embodiments, control may be returned to a calling process.

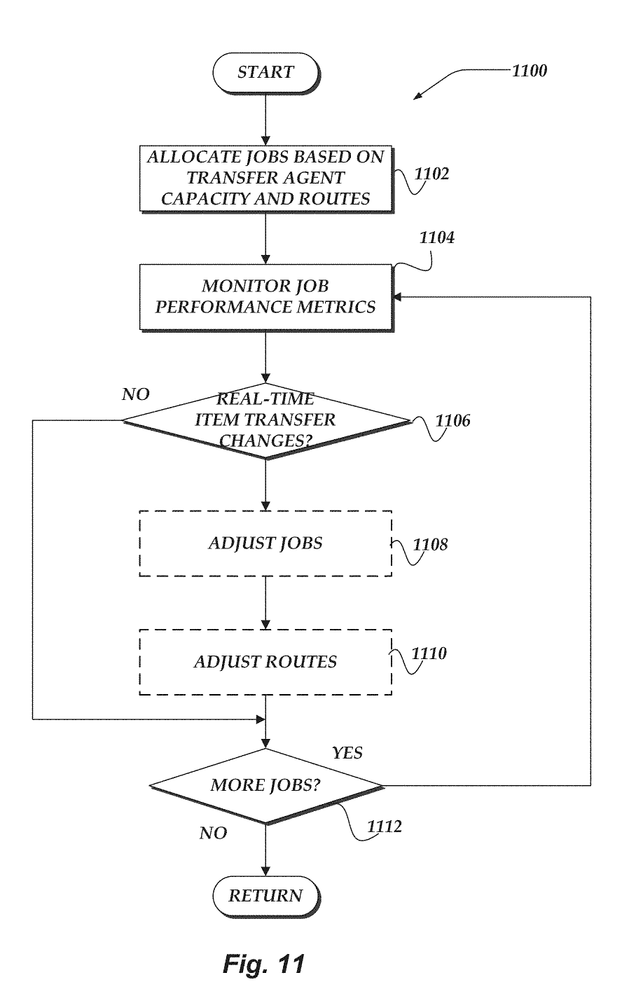

FIG. 11 illustrates a flowchart for process 1100 for providing real-time route modification in accordance with one or more of the various embodiments. After a start block, at block 1102, in one or more of the various embodiments, an inventory platform may be arranged to allocate pickup and delivery jobs to one or more transfer agents based on transfer agent capacity and defined routes. In one or more of the various embodiments, the inventory platform may be arranged to allocated jobs based on their associated appointment information (e.g., appointment slot information).

In one or more of the various embodiments, jobs may be grouped or sorted based on job type (e.g., pickup or delivery), job location, job size/volume, number of required operators/crew members, item type (e.g., standard size boxes, bulk items, special handling requirements, or the like), location type (e.g., single family homes, apartments, college dormitories, or the like), time of day, or the like, or combination thereof.

At block 1104, in one or more of the various embodiments, the inventory platform may be arranged to monitor the performance of jobs and collect job performance metrics. In one or more of the various embodiments, the one or more transfer agents may start performing jobs the included in their assigned routes. In one or more of the various embodiments, transfer agent operators may be enabled to see the routes, jobs, maps, traffic, user contact information, user custom instructions, or the like, using a client computer, such as a mobile computer, smartphone, or the like, that may be running an inventory client application, such as inventory client application 222, or the like.

In one or more of the various embodiments, the inventory platform may be arranged to track to status or performance of each route or each job or each transfer agent. In some embodiments, the inventory platform may be arranged to monitor the real-time location of each transfer agent. Also, in one or more of the various embodiments, the inventory platform may be arranged to monitor the time taken for each job. In one or more of the various embodiments, the various collected metrics may be stored for subsequent use. For example, in some embodiments, the inventory platform may be arranged to include a learning engine, such as learning engine 326 to generate predictive models, classifiers (e.g., deep learning), or the like, from the historical information include collected metrics.

Further, in one or more of the various embodiments, the inventory client application may be arranged to obtain input from transfer agent operators that may be used for adjusting or modifying routers. In some embodiments, transfer agent operators may input information related to the performance of one or more jobs one the route. In one or more of the various embodiments, transfer agent operators may recommend changes to the route or modifications to jobs. For example, a transfer agent operation may provide information such as the actual size/volume of a pickup. Accordingly, for example, if the ordered pickup job is larger and consumes more transfer agent space than predicted or expected, the transfer agent operator may be provide an update to the inventory platform. Likewise, for example, a transfer agent operator may provide updates related to jobs that may be unable to the complete, such as canceled jobs, inaccessible locations, unavailability of user/customer, or the like.

Also, in one or more of the various embodiments, transfer agent operator updates may indicate the actual beginning and end of jobs. The inventory platform may use this information to track route completion as well as to provide historical information that may be used by a machine learning engine to update one or more prediction models.

In one or more of the various embodiments, the inventory platform or the inventory client application client computer located in the transfer agents may be exchanging performance metric information by communicating over a network with unstable network quality. For example, since the transfer agent may be relying on wireless networks in urban or rural environments, the likelihood of network disconnects, packet drops, loss of signal, or the like, may be increased in such dynamic or congested network environments. Likewise, network communication may be degraded because of environment conditions, such as, weather, signal interference, or the like.

Accordingly, in one or more of the various embodiments, to optimize performance, reliability, and stability, the inventory client application client computer may be arranged to include one or more memories that may be used to cache the performance metrics if the inventory platform is inaccessible over a network. Accordingly, in one or more of the various embodiments, the inventory client application client computer may be arranged to adapt how performance metrics may be provided based on the quality or availability of network connectivity with the inventory platform. In one or more of the various embodiments, if the available network quality, based on band-width, throughput, congestion, stability, or the like, drops below a configured threshold, the inventory client application client computer may temporarily cache the performance metrics information in a local memory until the network quality is sufficiently restored. In some embodiments, if the network quality is restored the inventory client application may be arranged to send the cached performance metrics information to the inventory platform.

At decision block 1106, in one or more of the various embodiments, if there are changes or modifications to jobs on the route, control may flow to block 1108; otherwise, control may flow to decision block 1112. In one or more of the various embodiments, the inventory platform may be arranged to continually monitor the performance of jobs or routes for the one or more transfer agents that are out delivering or collecting items. Accordingly, in one or more of the various embodiments, the inventory platform may be arranged to compare one or more metrics the predicted outcomes, predictive models, one or more defined threshold values, one or more rule-based policies, or the like.

In one or more of the various embodiments, the inventory platform may be arranged to employ configuration information, including rule-based policies, to define various conditions or states that may initiate a re-evaluation or modification one or more of the current routes.

At block 1108, in one or more of the various embodiments, optionally, the inventory platform may be arranged to add or modify delivery or pickup jobs. In one or more of the various embodiments, information provided by transfer agent operators or customers may be used to modify or adjust individual jobs. For example, in one or more of the various embodiments, a customer may update pickup job information, this may increase or decrease the predicted size of the job which may impact the current appointment schedule or transfer agent capacity planning. Likewise, in one or more of the various embodiments, customers may cancel or reschedule jobs. In some cases, the customer may update the inventory platform to indicate that they may be running behind schedule, potentially causing a delay or extending the time it may take to finish a job.

In one or more of the various embodiments, a customer may be enabled to employ user-interface provided by an application such as, inventory client application 222, to provide job update information. In other embodiments, customers may provide job updates by telephone calls, texts, or emails to customer service portals of inventory platforms.

In one or more of the various embodiments, a user setting up a new pickup job may be presented an appointment slot that is associated with a transfer agent that is out servicing an assigned route. For example, if a transfer agent on the road has pickup job capacity, an appointment for that transfer agent may be presented to some users when they are requesting an appointment slot. Accordingly, in some embodiments, the user may be offered an appointment earlier than normal since a transfer agent with capacity is already out in the area. For example, the user may be offered an appointment that occurs on the same or in a few hours hence rather days in the future. In one or more of the various embodiments, the inventory platform may be arranged to offer pickup appointment slots that may be fulfilled by transfer agents already on the road that have unpredicted or unexpected capacity.

In one or more of the various embodiments, this block may be considered optional because the inventory platform may not be required or configured to adjust jobs or there may not be any jobs that require adjustment.

At block 1110, in one or more of the various embodiments, optionally, the inventory platform may be arranged to modify or adjust one or more routes. In one or more of the various embodiments, if the inventory platform (e.g., via its routing engine) determines that one or more routes should be modified it may adjust them appropriately. In some embodiments, route adjustments may include adding new routes or canceling/removing existing routes.

In one or more of the various embodiments, one or more additional transfer agents may be assigned to an existing route or existing job. For example, in some embodiments, if one or more delivery jobs in a route are canceled, the transfer agent servicing that route may not have the capacity to perform one or more pickup jobs. Accordingly, in this example, the inventory platform may assign the job to another transfer agent. In some embodiments, one or more stand-by transfer agents may be assigned a new route to perform scheduled jobs that the originally assigned transfer agents are unable to accomplish. In other embodiments, transfer agents currently servicing other routes may have one or more jobs assigned to them from other routes. For example, in one or more of the various embodiments, transfer agents working routes that have had pickup jobs cancelled may have unused capacity that may be directed to other jobs.

In some embodiments, jobs may be moved from one transfer agent's route to another transfer agent's route. In one or more of the various embodiments, the inventory platform may be arranged to provide a notification to the affected transfer agent/transfer agent operators via a routing client application. In some embodiments, if the transfer agent operators confirm or acknowledge the adjustments to their routes, the adjustments may become part of the transfer agent's current route.

In one or more of the various embodiments, this block may be considered optional because the inventory platform may not be required or configured to adjust routes or there might not be routes that require adjustment.

At decision block 1112, in one or more of the various embodiments, if there are more jobs to perform, control may loop back to block 1104; otherwise, control may be returned to a calling process. In one or more of the various embodiments, transfer agents may continue performing jobs as per their assigned routes. As transfer agents complete their assigned routes they may return collected items to the appropriate storage station. In some embodiments, as described above, if transfer agents have remaining cargo capacity, they may be re-assigned to other routes or have their routes adjusted. Accordingly, in one or more of the various embodiments, the inventory platform may be arranged to communicate route/job adjustments to a transfer agent operator. Alternatively, in some embodiments, the inventory platform may be arranged to send a return-to-base message to the transfer agent operator. Likewise, in some embodiments, routes may be arranged to include the storage station as a stop/job reflecting that collected items in a transfer agent need to be taken to a storage station for off-site storage.

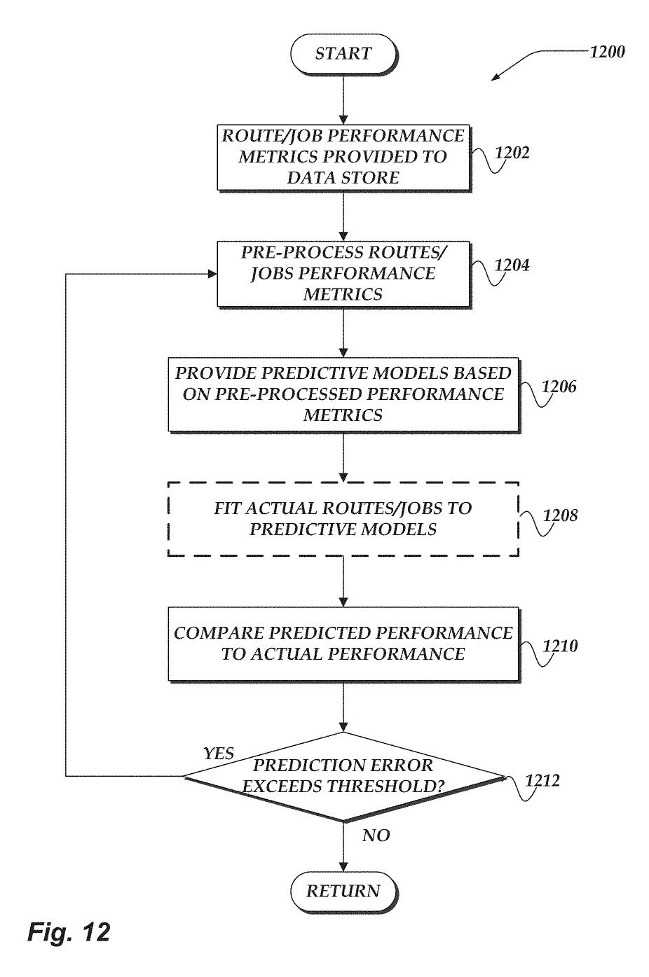

FIG. 12 illustrates a flowchart for process 1200 for providing predictive models for job and route performance in accordance with one or more of the various embodiments. After a start block, at block 1202, in one or more of the various embodiments, an inventory platform may be arranged to store performance metrics for one or more of the jobs or routes that may be performed. In one or more of the various embodiments, the performance metrics may be stored in a data store that may be accessed by a learning engine, such as learning engine 326.

In some embodiments, some performance metrics may be archived in low cost/high latency data storage. Other performance metrics may be stored in higher speed data storage. In one or more of the various embodiments, the inventory platform may be arranged to employ configuration to determine which metrics are archived. For example, in one or more of the various embodiments, configuration information may define parameters such as age thresholds to determine if metric should be moved to archival storage.

Likewise, in one or more of the various embodiments, the inventory platform may be arranged to capture performance metrics that may be used later or for future analysis. Accordingly, some performance metrics may be archived immediately since they may be currently unused by the learning engine.

In one or more of the various embodiments, the inventory platform may record various parameters associated with jobs, routes, or the like. In one or more of the various embodiments, job performance metrics may include, location, time of day, number of items, type of items, calendar information (e.g., holiday, weekend, day of week, or the like), transfer agent operator information, transfer agent type/size, job completion time, job delay time, job cancelations, customer information, lead time (e.g., when appointment was made), job adjustments, or the like.

In one or more of the various embodiments, route performance metrics may be similar or overlapping with job metrics but they may be geared toward a route as whole, such as, number of jobs, route path, route adjustments, start time, finish time, number of transfer agents, number of cancelled jobs, number of add-on jobs, number of delivery jobs, number of collecting jobs, or the like.

In one or more of the various embodiments, the collected metrics may be processed to provide aggregate metric values, data sketches, or the like. Accordingly, in one or more of the various embodiments, metrics represented by aggregate values or data sketches may be archived or discarded altogether. In one or more of the various embodiments, selecting the metrics of aggregation or data-sketching may be defined using configuration information, such as rule based policies, scripts, configuration registries, configuration files, or the like, or combination thereof.

At block 1204, in one or more of the various embodiments, the inventory platform may be arranged to pre-process some or all of the metrics associated with routes or jobs based on historical performance metrics. In one or more of the various embodiments, jobs or routes may be associated with various collected metrics, computed metrics, or the like. In one or more of the various embodiments, one or more metrics may be processed to format them for one or more machine learning processes. For example, in one or more of the various embodiments, metrics associated jobs or routes may be normalized and arranged to be compatible with various support vector machines (SVMs) comprising various learning engines that may be part of the inventory platform.

In one or more of the various embodiments, the selection of particular metrics and associate normalization or pre-processing, may be defined in configuration information. Accordingly, as users selectively pursue different types of predictive models or use different types of machine learning, a user may configure the inventory platform to process the raw performance metrics based on configuration information. In one or more of the various embodiments, some metrics may be designated for filtering, normalization, averaging, smoothing, time-bucketing, or the like. For example, filtering may include discarding outliers and smoothing may include time-bucket averaging (e.g., rolling averages), or the like. In one or more of the various embodiments, various metrics may be designated for inclusion in one or more support vectors, applied to linear regression modeling, included in aggregations, included in function to produce computed metrics, or the like, or combination thereof.

For example, in some embodiments, some metrics, such as, job completed, job canceled, or the like, may be configured to be added to support vectors as binary values (e.g., 0 or 1) whereas, other metrics such as, job delay, route duration, or the like, may be configured to be normalized to be real number value between 0 and 1. Likewise, for example, configuration information may be used to define the particular metrics that may be included as elements in various support vectors.

At block 1206, in one or more of the various embodiments, the inventory platform may be arranged to provide one or more predictive models based on the pre-processed performance metrics. In one or more of the various embodiments, a learning engine, such as learning engine 326 may be arranged to support one or more machine learning processes. For example, a learning engine may be comprised of one or more machine learning processes or modules arranged to provide different types of predictive models. In some embodiments, machine learning process may provide model based on artificial neural networks, deep learning networks, linear regression, support vector machines, learning classifier systems, Bayesian networks, genetic algorithms, or the like, or combination thereof.

Accordingly, in one or more of the various embodiments, the learning engine may be arranged to employ the appropriate pre-processed metrics to generate one or more predictive models. In some embodiments, configuration information may associate particular pre-processed metrics with particular machine learning engines to provide particular predictive models. For example, one or more support vectors provided at block 1204 may be designated to be provided to a support vector machine to generate one or more classifiers for identifying routes or jobs that may be predicted particular characteristics.

In one or more of the various embodiments, for some learning engines (e.g., deep learning networks, SVMs, or the like) the inventory platform may be arranged to store pre-classified test data that may be used to train or provide classifiers that may be for predictive models. In some embodiments, a metrics associated with jobs having known characteristics may be identified or selected for training models. For example, training data may include metrics associated with job delays exceeding a defined threshold, routes with an outsize number of job cancelations, routes completed ahead of schedule, routes where transfer agents returned with excess capacity, or the like.

Likewise, in one or more of the various embodiments, some types of predictive models, such as, multivariate linear regression models may be generated from other pre-processed metrics. The particular pre-processed metrics may be selected based on configuration information that defines the metrics used for different models.

Further, in one or more of the various embodiments, there may be different or separate models provided that target different aspects jobs or routes.

At block 1208, in one or more of the various embodiments, optionally, the inventory platform may be arranged to fit one or more routes or one or more jobs to one or more predictive models. In some embodiments, the inventory platform routing engine may be arranged to use one or more of the predictive models to evaluate potential routes, arrange/offer appointment slots, assigning transfer agents to routes, or the like.

Also, in one or more of the various embodiments, one or more predictive models may be used to estimate transfer agent capacity needed for a given time period. In one or more of the various embodiments, the inventory platform may employ a pickup volume model or a delivery volume model to plan the number of transfer agents to have available in a given period.

In one or more of the various embodiments, one or more predictive models may be used to identify outlying jobs, routes, or the like, to enable problems to be identified or corrected.

In one or more of the various embodiments, this block may be considered optional because the inventory platform may not be required or configured to fit jobs or routes to models or otherwise evaluate them based on predictive models.

At block 1210, in one or more of the various embodiments, the inventory platform may be arranged to compare the predicted performance to actual performance. In one or more of the various embodiments, the inventory platform's learning engine may be arranged to compare predicted results or predicted metrics provided by one or more predictive models with actual results or actual metrics that may be associated with completed jobs or routes.

In one or more of the various embodiments, the allowable or expected error range or deviation may be defined in configuration information. Accordingly, in one or more of the various embodiments, different predictive models may be assigned different error thresholds.

In one or more of the various embodiments, evaluating the performance/accuracy of predictive models enables the inventory platform to identify models that may require re-training or discarding.

In one or more of the various embodiments, the inventory platform may be arranged to score the one or more predicative models based on how close actual results match the predicted results.

At decision block 1212, in one or more of the various embodiments, if prediction errors exceed one or more threshold values, control may loop back to block 1204; otherwise, control may be returned to a calling process. In one or more of the various embodiments, some predictive models that may be performing poorly may be corrected or improved by retraining with updated or improved training data, such as, SVMs, or the like. In some embodiments, other failing models such as linear regression models, may be discarded and new models may be provided using updated pre-processed metrics.

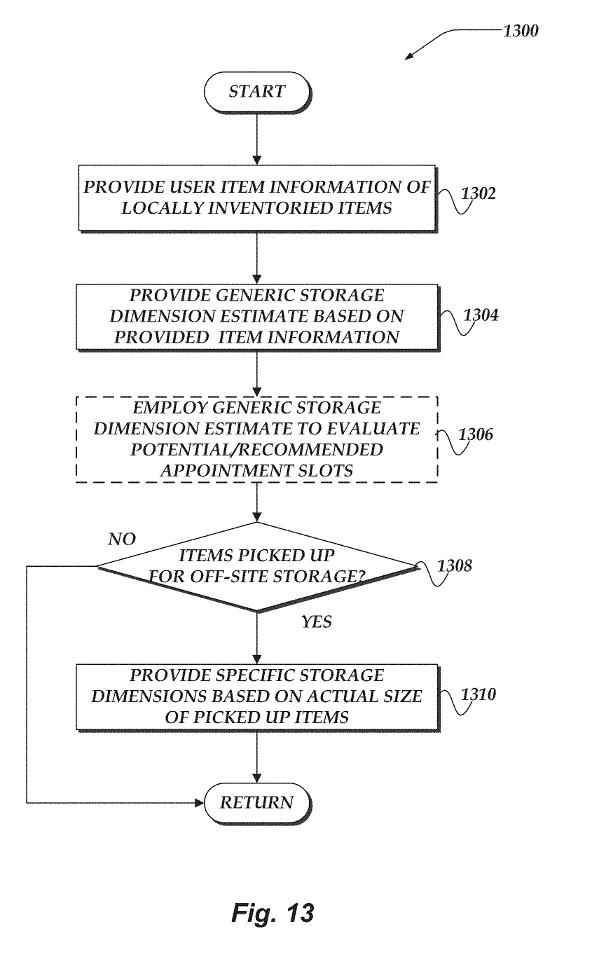

FIG. 13 illustrates a flowchart for process 1300 for managing storage dimensions in accordance with one or more of the various embodiments. After a start block, at block 1302, in one or more of the various embodiments, item information associated with locally stored items may be provided to an inventory engine. As discussed above, item information may be associated with items that a user may have in their inventory or items the user intends to add to their inventory.

In one or more of the various embodiments, users may provide dimension information for one or more of their items. For example, in some embodiments, the user may manually enter dimension information based on their own measurements or estimates.

At block 1304, in one or more of the various embodiments, the inventory engine may be arranged to provide generic storage dimension estimates for one or more of the users items based on the provided item information. In one or more of the various embodiments, the inventory engine may be arranged to estimate storage dimensions for items based on dimensions entered by users. Also, in one or more of the various embodiments, the inventory engine may be arranged to provide initial or generic dimension estimates based on item information (e.g., brand, make, model, or the like) provided by users.

In one or more of the various embodiments, the inventory engine may collect information such as SKU or other identifying features/labels on the items based on users scanning the items with a mobile computer, smart-phone camera, or the like. Accordingly, in some embodiments, the inventory engine may obtain estimated or generic dimensions from a databased of known items/item types.

In one or more of the various embodiments, if users are unable or unwilling to supply item identifiers (e.g., SKUs, make/model, product IDs, or the like), the inventory engine may supply generic dimension values that based on common or average dimensions for a given item type. For example, if some are items generally identified as “folding deck chairs,” the inventory engine may obtain generic dimensions for the items based on dimensions for similar items that may be recorded in an item dimension database. In some embodiments, the inventory engine may be arranged to maintain different generic dimension values for different circumstances. Accordingly, in one or more of the various embodiments, item type generic dimension values may be regionally adjusted based on local trends, adjusted based on user demographic information, or the like, or combination thereof.

Accordingly, in one or more of the various embodiments, the inventory platform may be arranged to include a database of known item types that include dimension information. In one or more of the various embodiments, the item dimension information may be provided or associated with item retailers or manufacturers that provide the dimension information. Also, in some embodiments, the inventory management platform may update its dimensions database as items are added by users.

At block 1306, in one or more of the various embodiments, optionally, the inventory engine or a routing engine may be arranged to employ the generic storage dimensions during the selection of candidate appointment slots for a user intending to transfer one or more items from local storage to an off-site storage station. In one or more of the various embodiments, among other things, the generic storage dimensions, may be used to identify candidate appointment slots that may have capacity for pickup of the items associated with generic storage dimension estimates.

Also, in one or more of the various embodiments, the inventory management platform may be arranged to employ additional dimension information (e.g., more than just generic storage dimensions) if relevant dimension information is available. For example, in some embodiments, actual or confirmed dimension information previously obtained or stored in a database may be used as well as the generic storage dimension information.

In one or more of the various embodiments, this block is optional because users may request or review appointment slots in anticipation of making pickup or delivery requests. Accordingly, in one or more of the various embodiments, block 1306 may be omitted until a user needs an appointment slot for picking up items.

At decision block 1308, in one or more of the various embodiments, if the user employs an inventory platform to transfer one or more items associated with generic storage dimensions to a storage station, control may flow to block 1310; otherwise, control may be returned to a calling process. In one or more of the various embodiments, as described above, a user may select or identify one or more user items to be picked up and transferred to a storage station.

At block 1310, in one or more of the various embodiments, the inventory engine may be arranged to provide specific storage dimensions for the picked up items that may be based on the actual dimensions of the picked up items. In one or more of the various embodiments, since user items may be uniquely labeled, the actual storage dimensions for items received by the inventory platform may be added to the item information. Accordingly, in some embodiments, from then on, the inventory engine or routing engine may be arranged to employ on these actual specific dimension values rather than generic storage dimension estimates.

In one or more of the various embodiments, van operators or other staff may measure the actual items at the time of pickup. Accordingly, in some embodiments, the routing engine may be arranged to dynamically update van capacity information as the specific item storage dimensions are entered in the system.

In one or more of the various embodiments, an inventory client application may be running on a client computer that is operating offline rather than connected to a network. Accordingly, in one or more of the various embodiments, the inventory client application may be arranged to store the specific dimension information locally on the operator's client computer. Thus, in some embodiments, the inventory client application may be arranged to upload its locally stored specific storage dimension information if network connectivity with the inventory management platform may be restored.

In one or more of the various embodiments, the inventory engine may be arranged to employ one or more machine vision system for automatically determining the dimensions or items received at a storage station. For example, in some embodiments, as items are unloaded from a transfer agent (.e.g., cargo van) their dimensions may be measured using optical sensors, or the like. In some embodiments, items may be placed on a conveyor or other automatic travel system that enables the inventory platform to measure the dimension of each item stored at a storage station.

Alternatively, in one or more of the various embodiments, the specific or actual dimensions for items may be determined or confirmed at the time of pickup. In some embodiments, van operators may employ handheld sensor (e.g., video cameras) that use machine vision to determine actual item dimensions, as well as manually entering dimensions for picked up items. In some embodiments, the handheld sensors may be arranged to provide the sensor data, such as, video to remote inventory engine that may be arranged to process the sensor data to compute the actual or specific dimensions of the picked up items.

In one or more of the various embodiments, the specific storage dimension values may correct errors that may have been introduced by users. For example, in some embodiments, a user may have provided item information indicating that an item is in a 50 cm by 100 cm box, when in actuality the item is stored in a 80 cm by 100 cm box. Likewise, in one or more of the various embodiments, a user may have entered an incorrect brand, make, model, or the like, causing the inventory platform to incorrectly estimate the dimensions of the item. Accordingly, in one or more of the various embodiments, if the item is picked up by the inventory platform, these user introduced errors may be corrected and stored with the item information for the item. In one or more of the various embodiments, the inventory engine may be arranged to distinguish between generic dimension estimates and generic estimates. For example, the information may be arranged to include generic dimensions estimates separate from specific or actual dimension values so it may distinguish whether the dimensions for items are based on generic estimates or specific dimensions.

In one or more of the various embodiments, staff or operators as one or more offsite storage stations may be enabled to periodically measure one or more items located/stored at their location. Accordingly, in one or more of the various embodiments, the inventory management platform may be arranged to compare the current recorded dimension information for items with dimension values measured or collected at the storage station and update them accordingly.

Likewise, in one or more of the various embodiments, the inventory engine may be arranged to enable users (e.g., item owners) to challenge or update the storage dimensions associated with their items. For example, if a user identifies an item in the inventory associated with incorrect storage dimensions, the inventory management platform may be arranged to enable the user to submit a notification of the discrepancy or error, provide corrected storage dimensions, or the like.

In one or more of the various embodiments, one or more rule-based policies may be defined that limit or enable the user to change storage dimension values. In some embodiments, one or more change proposed by a user may need to be approved by administrators or operators of the inventory management platform before being accepted.

Next, in some embodiments, control may be returned to a calling process.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor to provide steps for implementing the actions specified in the flowchart block or blocks. The computer program instructions may also cause at least some of the operational steps shown in the blocks of the flowchart to be performed in parallel. These program instructions may be stored on some type of machine readable storage media, such as processor readable non-transitive storage media, or the like. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems, which perform the specified actions or steps, or combinations of special purpose hardware and computer instructions. The foregoing example should not be construed as limiting and/or exhaustive, but rather, an illustrative use case to show an implementation of at least one of the various embodiments of the invention.

1. A method for managing an inventory of items over a network using a network computer that includes one or more processors that execute instructions to perform the method, comprising:
instantiating an inventory engine to perform actions, including:
collecting information provided by a user of a client computer over a network and provide to the user one or more appointment slots based on item transfer information provided by the user and other item transfer information provided by one or more other users of one or more other client computers over the network; and
employing geolocation information provided by a separate global positioning system (GPS) device to selectively localize one or more included features for one or more of user interfaces, reports, or databases, wherein the localization features include time zones, languages, currencies, and calendar formatting, and wherein the one or more included features improve the user's understanding of the user interfaces, reports or databases that are displayed to the user of the client computer when the client computer is located at a particular geo-location; and
instantiating a routing engine to perform actions, including:
providing one or more jobs based on each selection of the one or more appointment slots by the user;
characterizing the one or more jobs based on a type of job and a location included with the item transfer information;
providing one or more routes to perform the one or more jobs, wherein each route is associated with one or more transfer agents; and
providing metrics for the one or more transfer agents based on monitoring one or more actions of the one or more transfer agents, wherein the one or more monitored actions are stored in a remote data store; and
instantiating a learning engine to perform actions, including:
comparing the metrics to one or more predictive models, wherein the one or more predictive models are based on previously obtained metrics; and
employing the one or more predictive models to modify the one or more routes based on the comparison, wherein the modification of the one or more routes includes editing one or more characterizations of the one or more jobs to provide the one or more modified routes to the one or more transfer agents.

2. The method of claim 1, further comprising employing the inventory engine to perform further actions, including providing delivery instructions and pickup instructions to the one or more transfer agents, wherein the delivery instructions and the pickup instructions are based on the one or more jobs and the one or more routes.

3. The method of claim 1, wherein employing the one or more predictive models to modify the one or more routes, further comprises, modifying one or more paths to one or more of the jobs that are associated with the one or more routes based on the provided metrics.

4. The method of claim 1, further comprising employing the inventory engine to perform further actions, including:
rank ordering the one or more appointment slots based on the transfer information and the other transfer information; and
scoring appointment slots for item pickup based on their time window, wherein item pickup appointment slots that have time windows that are later in time than previously scheduled delivery jobs are scored higher than item pickup appointment slots that have time windows that occur before the previously scheduled delivery jobs.

5. The method of claim 1, further comprising employing the inventory engine to perform further actions, including:
rank ordering the one or more appointment slots based on the transfer information and the other transfer information; and
scoring appointment slots based on availability of the one or more transfer agents, wherein more transfer agent capacity is scored higher than less transfer agent capacity.

6. The method of claim 1, further comprising employing the inventory engine to perform further actions, including providing one or more appointment slots for item pickup that are associated with the one or more transfer agents that are currently performing a route, wherein the one or more transfer agents have excess available capacity to transfer one or more items.

7. The method of claim 1, further comprising employing the learning engine to perform further actions, including:
employing the one or more predictive models to predict one or more metrics for the one or more routes;
comparing the one or more predicted metrics to the provided metrics; and
retraining each predictive model that is associated with a variance that exceeds a defined value.

8. A system for managing an inventory of items, comprising:
a network computer, comprising:
a transceiver that communicates over the network;
a memory that stores at least instructions; and
one or more processor devices that execute instructions that perform actions, including:
instantiating an inventory engine to perform actions, including:
collecting information provided by a user of a client computer over a network and provide to the user one or more appointment slots based on item transfer information provided by the user and other item transfer information provided by one or more other users of one or more other client computers over the network; and
employing geolocation information provided by a separate global positioning system (GPS) device to selectively localize one or more included features for one or more of user interfaces, reports, or databases, wherein the localization features include time zones, languages, currencies, and calendar formatting, and wherein the one or more included features improve the user's understanding of the user interfaces, reports or databases that are displayed to the user of the client computer when the client computer is located at a particular geo-location; and
instantiating a routing engine to perform actions, including:
providing one or more jobs based on each selection of the one or more appointment slots by the user;
characterizing the one or more jobs based on a type of job and a location included with the item transfer information;
providing one or more routes to perform the one or more jobs, wherein each route is associated with one or more transfer agents; and
providing metrics for the one or more transfer agents based on monitoring one or more actions of the one or more transfer agents, wherein the one or more monitored actions are stored in a remote data store; and
instantiating a learning engine to perform actions, including:
comparing the metrics to one or more predictive models, wherein the one or more predictive models are based on previously obtained metrics; and
employing the one or more predictive models to modify the one or more routes based on the comparison, wherein the modification of the one or more routes includes editing one or more characterizations of the one or more jobs to provide the one or more modified routes to the one or more transfer agents; and
the one or more client computers, comprising:
a client computer transceiver that communicates over the network;
a client computer memory that stores at least instructions; and
one or more processor devices that execute instructions that perform actions, including:
displaying the one or more appointment slots in rank order; and
providing the item transfer information to the network computer.

9. The system of claim 8, wherein the one or more network computer processor devices execute instructions that perform actions, further comprising employing the inventory engine to perform further actions, including providing delivery instructions and pickup instructions to the one or more transfer agents, wherein the delivery instructions and the pickup instructions are based on the one or more jobs and the one or more routes.

10. The system of claim 8, wherein employing the one or more predictive models to modify the one or more routes, further comprises, modifying one or more paths to one or more of the jobs that are associated with the one or more routes based on the provided metrics.

11. The system of claim 8, further comprising employing the inventory engine perform further actions, including:
rank ordering the one or more appointment slots based on the transfer information and the other transfer information; and
scoring appointment slots for item pickup based on their time window, wherein item pickup appointment slots that have time windows that are later in time than previously scheduled delivery jobs are scored higher than item pickup appointment slots that have time windows that occur before the previously scheduled delivery jobs.

12. The system of claim 8, wherein the one or more network computer processor devices execute instructions that perform actions, further comprising employing the inventory engine to perform further actions, including:
rank ordering the one or more appointment slots based on the transfer information and the other transfer information; and
scoring appointment slots based on availability of the one or more transfer agents, wherein more transfer agent capacity is scored higher than less transfer agent capacity.

13. The system of claim 8, wherein the one or more network computer processor devices execute instructions that perform actions, further comprising employing the inventory engine to perform further actions, including providing one or more appointment slots for item pickup that are associated with the one or more transfer agents that are currently performing a route, wherein the one or more transfer agents have excess available capacity to transfer one or more items.

14. The system of claim 8, wherein the one or more network computer processor devices execute instructions that perform actions, further comprising employing the learning engine to perform further actions, including:
employing the one or more predictive models to predict one or more metrics for the one or more routes;
comparing the one or more predicted metrics to the provided metrics; and
retraining each predictive model that is associated with a variance that exceeds a defined value.

15. A processor readable non-transitory storage media that includes instructions for managing an inventory of items, wherein execution of the instructions by one or more hardware processors performs actions, comprising:
instantiating an inventory engine to perform actions, including:
collecting information provided by a user of a client computer over a network and provide to the user one or more appointment slots based on item transfer information provided by the user and other item transfer information provided by one or more other users of one or more other client computers over the network; and
employing geolocation information provided by a separate global positioning system (GPS) device to selectively localize one or more included features for one or more of user interfaces, reports, or databases, wherein the localization features include time zones, languages, currencies, and calendar formatting, and wherein the one or more included features improve the user's understanding of the user interfaces, reports or databases that are displayed to the user of the client computer when the client computer is located at a particular geo-location; and
instantiating a routing engine to perform actions, including:
providing one or more jobs based on each selection of the one or more appointment slots by the user;
characterizing the one or more jobs based on a type of job and a location included with the item transfer information;
providing one or more routes to perform the one or more jobs, wherein each route is associated with one or more transfer agents; and
providing metrics for the one or more transfer agents based on monitoring one or more actions of the one or more transfer agents, wherein the one or more monitored actions are stored in a remote data store; and
instantiating a learning engine to perform actions, including:
comparing the metrics to one or more predictive models, wherein the one or more predictive models are based on previously obtained metrics; and
employing the one or more predictive models to modify the one or more routes based on the comparison, wherein the modification of the one or more routes includes editing one or more characterizations of the one or more jobs to provide the one or more modified routes to the one or more transfer agents.

16. The media of claim 15, further comprising employing the inventory engine to perform further actions, including providing delivery instructions and pickup instructions to the one or more transfer agents, wherein the delivery instructions and the pickup instructions are based on the one or more jobs and the one or more routes.

17. The media of claim 15, wherein employing the one or more predictive models to modify the one or more routes, further comprises, modifying one or more paths to one or more of the jobs that are associated with the one or more routes based on the provided metrics.

18. The media of claim 15, further comprising employing the inventory engine to perform further actions, including:
rank ordering the one or more appointment slots based on the transfer information and the other transfer information; and
scoring appointment slots for item pickup based on their time window, wherein item pickup appointment slots that have time windows that are later in time than previously scheduled delivery jobs are scored higher than item pickup appointment slots that have time windows that occur before the previously scheduled delivery jobs.

19. The media of claim 15, further comprising employing the inventory engine to perform further actions, including:
rank ordering the one or more appointment slots based on the transfer information and the other transfer information; and
scoring appointment slots based on availability of the one or more transfer agents, wherein more transfer agent capacity is scored higher than less transfer agent capacity.

20. The media of claim 15, further comprising employing the inventory engine to perform further actions, including providing one or more appointment slots for item pickup that are associated with the one or more transfer agents that are currently performing a route, wherein the one or more transfer agents have excess available capacity to transfer one or more items.

21. The media of claim 15, further comprising employing the learning engine to perform further actions, including:
employing the one or more predictive models to predict one or more metrics for the one or more routes;
comparing the one or more predicted metrics to the provided metrics; and
retraining each predictive model that is associated with a variance that exceeds a defined value.

22. A network computer for managing an inventory of items, comprising:
a transceiver that communicates over the network;
a memory that stores at least instructions; and
one or more processor devices that execute instructions that perform actions, including:
instantiating art inventory engine to perform actions, including:
collecting information provided by a user of a client computer over a network and provide to the user one or more appointment slots based on item transfer information provided by the user and other item transfer information provided by one or more other users of one or more other client computers over the network; and
employing geolocation information provided by a separate global positioning system (GPS) device to selectively localize one or more included features for one or more of user interfaces, reports, or databases, wherein the localization features include time zones, languages, currencies, and calendar formatting, and wherein the one or more included features improve the user's understanding of the user interfaces, reports or databases that are displayed to the user of the client computer when the client computer is located at a particular geo-location; and
instantiating a routing engine to perform actions, including:
providing one or more jobs based on each selection of the one or more appointment slots by the user;
characterizing the one or more jobs based on a type of job and a location included with the item transfer information;
providing one or more routes to perform the one or more jobs, wherein each route is associated with one or more transfer agents; and
providing metrics for the one or more transfer agents based on monitoring one or more actions of the one or more transfer agents, wherein the one or more monitored actions are stored in a remote data store; and
instantiating a learning engine to perform actions, including:
comparing the metrics to one or more predictive models, wherein the one or more predictive models are based on previously obtained metrics; and
employing the one or more predictive models to modify the one or more routes based on the comparison, wherein the modification of the one or more routes includes editing one or more characterizations of the one or more jobs to provide the one or more modified routes to the one or more transfer agents.

23. The network computer of claim 22, further comprising employing the inventory engine to perform further actions, including providing delivery instructions and pickup instructions to the one or more transfer agents, wherein the delivery instructions and the pickup instructions are based on the one or more jobs and the one or more routes.

24. The network computer of claim 22, wherein employing the one or more predictive models to modify the one or more routes, further comprises, modifying one or more paths to one or more of the jobs that are associated with the one or more routes based on the provided metrics.

25. The network computer of claim 22, further comprising employing the inventory engine to perform further actions, including:
rank ordering the one or more appointment slots based on the transfer information and the other transfer information; and
scoring appointment slots for item pickup based on their time window, wherein item pickup appointment slots that have time windows that are later in time than previously scheduled delivery jobs are scored higher than item pickup appointment slots that have time windows that occur before the previously scheduled delivery jobs.

26. The network computer of claim 22, further comprising employing the inventory engine to perform further actions, including:
rank ordering the one or more appointment slots based on the transfer information and the other transfer information; and
scoring appointment slots based on availability of the one or more transfer agents, wherein more transfer agent capacity is scored higher than less transfer agent capacity.

27. The network computer of claim 22, further comprising employing the inventory engine to perform further actions, including providing one or more appointment slots for item pickup that are associated with the one or more transfer agents that are currently performing a route, wherein the one or more transfer agents have excess available capacity to transfer one or more items.

28. The network computer of claim 22, further comprising employing the learning engine to perform further actions, including:
employing the one or more predictive models to predict one or more metrics for the one or more routes;
comparing the one or more predicted metrics to the provided metrics; and
retraining each predictive model that is associated with a variance that exceeds a defined value.
